(19) United States
(12) Patent Application Publication
(10) Pub. No.: US 2026/0288895 A1
(43) Pub. Date: Sep. 24, 2026

(54) CALCULATION APPARATUS, CALCULATION METHOD, AND COMPUTER PROGRAM PRODUCT

(71) Applicants: KABUSHIKI KAISHA TOSHIBA, Kawasaki-shi Kanagawa (JP); TOSHIBA DIGITAL SOLUTIONS CORPORATION, Kawasaki-shi Kanagawa (JP)

(72) Inventor: Masaru SUZUKI, Ota Tokyo (JP)

(73) Assignees: KABUSHIKI KAISHA TOSHIBA, Kawasaki-shi Kanagawa (JP); TOSHIBA DIGITAL SOLUTIONS CORPORATION, Kawasaki-shi Kanagawa (JP)

(21) Appl. No.: 19/574,674

(22) Filed: Mar. 23, 2026

(30) Foreign Application Priority Data
Mar. 24, 2025 (JP) 2025-047699

(51) Int. Cl. G06F 17/13; G06F 30/25; G06F 111/10

(52) U.S. Cl. CPC G06F 17/13; G06F 30/25; G06F 2111/10

(57) ABSTRACT

A calculation apparatus alternately repeats momentum update processing and position update processing every unit time. The momentum update processing includes updating an i-th momentum variable among N momentum variables by adding a value obtained by multiplying unit time by a value obtained by partial differentiation on a Hamiltonian with an i-th position variable among N position variables. The position update processing includes updating the i-th position variable by adding a value obtained by multiplying unit time by a value obtained by partial differentiation on the Hamiltonian with the i-th momentum variable. The Hamiltonian calculates a stable point at the initial time, which indicates a value of each of the N position variables in which each of the N momentum variables is 0. Each of the N position variables at the initial time is a value obtained by adding a normal random number to the stable point at the initial time.

### CROSS-REFERENCE TO RELATED APPLICATIONS

This application is based upon and claims the benefit of priority from Japanese Patent Application No. 2025-047699, filed Mar. 24, 2025, the entire contents of which are incorporated herein by reference.

### FIELD

Embodiments described herein relate generally to a calculation apparatus, a calculation method, and a computer program product.

### BACKGROUND

An algorithm for solving an Ising problem by simulation using a concept of Hamiltonian or energy has been known. For example, there is a simulated bifurcation algorithm that is an algorithm for solving the Ising problem using the concept of the Hamiltonian.

The simulated bifurcation algorithm simulates temporal changes in motion of a plurality of virtual particles. The simulated bifurcation algorithm represents the Hamiltonian by a position variable representing the position of each of the virtual particles, a momentum variable representing the momentum of each of the virtual particles, and an interaction and an external magnetic field coefficient in the Ising problem.

The simulated bifurcation algorithm performs simulation of temporally evolving the Hamiltonian while decreasing the adiabatic effect parameter with the lapse of time, and calculates the solution to the Ising problem on the basis of the position of each of the virtual particles at the time (end time) when the adiabatic effect parameter becomes 0.

In such an algorithm, it is known that, in a case of solving an Ising problem in which a coefficient vector representing an external magnetic field coefficient is large as compared with a coefficient matrix representing an interaction, accuracy of a solution deteriorates, or a calculation amount is increased. This is because the momentum of the virtual particles is large, and thereby the positions of the virtual particles become unstable. As a result, the time until the positions of the virtual particles are stabilized becomes long in the initial stage of the simulation.

### BRIEF DESCRIPTION OF THE DRAWINGS

FIG. 1 is a diagram illustrating a configuration of a solving system according to an embodiment;

FIG. 2 is a diagram illustrating a graph cut problem;

FIG. 3 is a diagram illustrating contour lines of a graph cut function;

FIG. 4 is a diagram illustrating contour lines of a penalty function;

FIG. 5 is a diagram illustrating contour lines of an augmented Lagrangian function;

FIG. 6 is a diagram illustrating a configuration of a calculation apparatus;

FIG. 7 is a flowchart illustrating a procedure of processing of the calculation apparatus;

FIG. 8 is a diagram illustrating changes of contour lines of the conventional Hamiltonian (H₀) in the case of c=1×10⁻¹;

FIG. 9 is a diagram illustrating changes of contour lines of the conventional Hamiltonian (H₀) in the case of c=1×10⁻²;

FIG. 10 is a diagram illustrating changes of contour lines of the conventional Hamiltonian (H₀) in the case of c=1×10⁻³;

FIG. 11 is a flowchart illustrating a procedure of processing of a calculation apparatus in a first example;

FIG. 12 is a diagram illustrating changes of contour lines of the Hamiltonian (H₁) of the first example in the case of c=1×10⁻¹;

FIG. 13 is a diagram illustrating changes of contour lines of the Hamiltonian (H₁) of the first example in the case of c=1×10⁻²;

FIG. 14 is a diagram illustrating changes of contour lines of the Hamiltonian (H₁) of the first example in the case of c=1×10⁻³;

FIG. 15 is a flowchart illustrating a procedure of processing of a calculation apparatus in a second example;

FIG. 16 is a diagram illustrating changes of contour lines of the Hamiltonian (H₂) of the second example in the case of c=1×10⁻¹.

FIG. 17 is a diagram illustrating changes of contour lines of the Hamiltonian (H₂) of the second example in the case of c=1×10⁻²;

FIG. 18 is a diagram illustrating changes of contour lines of the Hamiltonian (H₂) of the second example in the case of c=1×10⁻³;

FIG. 19 is a flowchart illustrating a procedure of processing of a calculation apparatus in a third example;

FIG. 20 is a diagram illustrating changes of contour lines of the Hamiltonian (H₃) of the third example in the case of c=1×10⁻¹;

FIG. 21 is a diagram illustrating changes of contour lines of the Hamiltonian (H₃) of the third example in the case of c=1×10⁻²;

FIG. 22 is a diagram illustrating changes of contour lines of the Hamiltonian (H₃) of the third example in the case of c=1×10⁻³;

FIG. 23 is a flowchart illustrating a procedure of processing of a calculation apparatus in a fourth example;

FIG. 24 is a diagram illustrating changes of contour lines of the Hamiltonian (H₄) of the fourth example in the case of c=1×10⁻¹;

FIG. 25 is a diagram illustrating changes of contour lines of the Hamiltonian (H₄) of the fourth example in the case of c=1×10⁻²;

FIG. 26 is a diagram illustrating changes of contour lines of the Hamiltonian (H₄) of the fourth example in the case of c=1×10⁻³;

FIG. 27 is a diagram illustrating calculation amounts of the first example and the second example in the related art;

FIG. 28 is a diagram illustrating calculation amounts of the third example and the fourth example; and

FIG. 29 is a diagram illustrating an example of a hardware configuration of a computer.

### DETAILED DESCRIPTION

A calculation apparatus according to an embodiment serves to solve a minimization problem of minimizing a non-convex quadratic objective function including N spin variables (N is an integer greater than or equal to 2). The calculation apparatus includes a hardware processor connected to a memory. The hardware processor is configured to simulate, for each unit time from an initial time to an end time, a position and a momentum of each of N virtual particles while reducing an adiabatic change parameter of a Hamiltonian over time. The hardware processor is configured to calculate a value of each of the N spin variables based on the corresponding position of each of the N virtual particles at the end time and output the calculated value of each of the N spin variables as a solution to the minimization problem. The N spin variables correspond one-to-one to the N virtual particles. The Hamiltonian is represented by N position variables, N momentum variables, the adiabatic change parameter, a N-by-N coefficient matrix representing a coefficient group of quadratic terms included in the non-convex quadratic objective function, and a N-row coefficient vector representing a coefficient group of linear terms included in the non-convex quadratic objective function. The N position variables correspond one-to-one to the N virtual particles. Each of the N position variables represents a position of a corresponding virtual particle among the N virtual particles. The N momentum variables correspond one-to-one to the N virtual particles. Each of the N momentum variables represents a momentum of a corresponding virtual particle among the N virtual particles. The hardware processor is configured to acquire the coefficient matrix and the coefficient vector, and set respective values of the N position variables and respective values of the N momentum variables at the initial time. The hardware processor is configured to alternately repeat momentum update processing and position update processing for each unit time. The momentum update processing is processing of updating an i-th momentum variable (i is an integer from 1 to N both inclusive) among the N momentum variables by adding, to the i-th momentum variable, a value obtained by multiplying the unit time by a value obtained by performing partial differentiation on the Hamiltonian with an i-th position variable among the N position variables. The position update processing is processing of updating the i-th position variable by adding, to the i-th position variable, a value obtained by multiplying the unit time by a value obtained by performing partial differentiation on the Hamiltonian with the i-th momentum variable. The Hamiltonian is capable of calculating a stable point at the initial time. The stable point indicates a value of each of the N position variables in which each of the N momentum variables is 0. Each of the N position variables at the initial time is a value obtained by adding a normal random number to the stable point at the initial time.

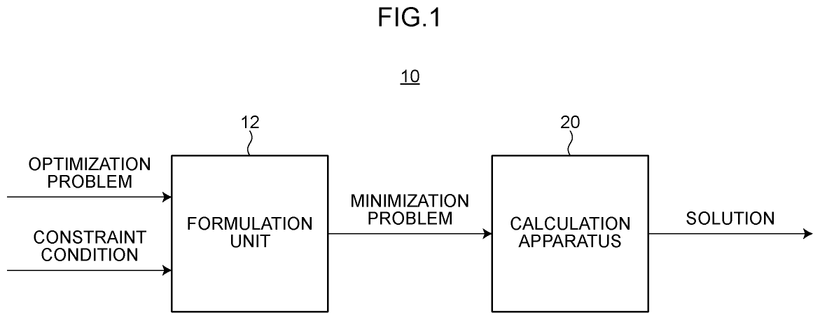

FIG. 1 is a diagram illustrating a configuration of a solving system 10 according to an embodiment.

The solving system 10 includes a formulation unit 12 and a calculation apparatus 20.

The formulation unit 12 acquires an optimization problem and a constraint condition given from a user or another apparatus. The formulation unit 12 generates an unconstrained minimization problem that minimizes a non-convex quadratic objective function including N spin variables (N is an integer greater than or equal to 2) on the basis of the optimization problem and the constraint condition. For example, the formulation unit 12 generates a minimization problem that minimizes an augmented Lagrangian function including N spin variables.

The calculation apparatus 20 solves the minimization problem generated by the formulation unit 12 using the concept of the Hamiltonian. For example, the calculation apparatus 20 solves the minimization problem by a simulated bifurcation algorithm. Note that the calculation apparatus 20 may solve the minimization problem given from the user or another apparatus, for example, instead of acquiring the minimization problem from the formulation unit 12. The calculation apparatus 20 outputs the solution obtained by solving.

In the present embodiment, a minimization problem of minimizing a non-convex quadratic objective function including N spin variables is defined by Formula (1).

$${minimize}_{s} ( \frac{1}{2} {s}^{T} \cdot {J}_{i , j} \cdot s + {h}^{T} \cdot s ) \qquad ( 1 )$$

The contents in parenthesis in Formula (1) represents a non-convex quadratic objective function including N spin variables.

s is an N-dimensional vector representing N spin variables. Note that the N-dimensional vector is a N-by-1 matrix. Specifically, s is defined by Formula (2).

$${J}_{i , i} = 0 , 1 \leq i \leq N \qquad ( 3 )$$

That is, each of the N spin variables is a binary variable representing either −1 or +1. Note that N on the right shoulder of the right side of Formula (2) represents the number of dimensions.

J represents a N-by-N coefficient matrix representing a coefficient group of quadratic terms included in the non-convex quadratic objective function. J_{i,i}, which is an element in the i-th row and i-th column included in J, becomes 0, as defined by Formula (3).

$$s ∈ {\{ - 1 , + 1 \}}^{N} \qquad ( 2 )$$

i is an integer from 1 to N both inclusive. Thus, J is a square matrix, the diagonal components of which are 0.

J_{i,j}, which is an element in the i-th row and j-th column included in J, is defined by Formula (4).

$${J}_{i , j} = {J}_{j , i} ∈ ℝ , 1 \leq i \leq j \leq N \qquad ( 4 )$$

Thus, J_{i,j} is the same as J_{j,i}, which is an element in the j-th row and i-th column included in J, and is a real number. j is an integer from 1 to N, both inclusive, and is greater than i.

h is a coefficient vector of N rows representing a coefficient group of linear terms included in the non-convex quadratic objective function. Specifically, h is defined by Formula (5).

$$h ∈ {ℝ}^{N} \qquad ( 5 )$$

Thus, the N elements included in h are real numbers.

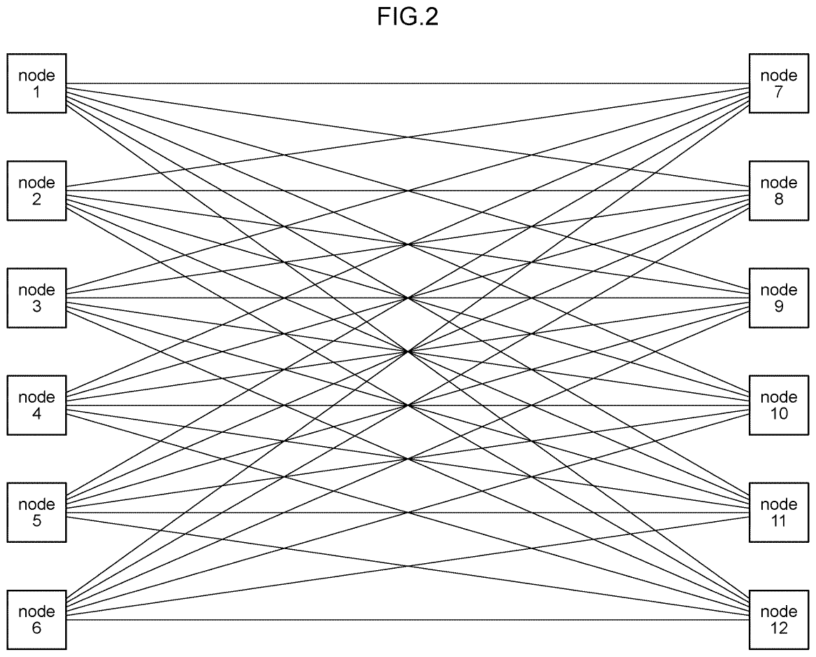

FIG. 2 is a diagram illustrating a graph cut problem.

In describing the present embodiment, a case in which an optimization problem to be solved by the solving system 10 is a graph cut problem will be described as an example. Note that the solving system 10 can solve not only the graph cut problem but also other optimization problems.

A graph to be subjected to the graph cut problem in the present example includes 12 nodes (the first node to the twelfth node). The 12 nodes include six nodes (the first node to the sixth node) belonging to a first group and six nodes (the seventh node to the twelfth node) belonging to a second group. Each of the six nodes (the first node to the sixth node) belonging to the first group is connected to each of the six nodes (the seventh node to the twelfth node) belonging to the second group by an edge. Further, each of the six nodes (the seventh node to the twelfth node) belonging to the second group is connected to each of the six nodes (the first node to the sixth node) belonging to the first group by an edge.

In the present example, the graph cut problem is a problem of dividing 12 nodes into: one or more nodes belonging to a plus group, and one or more nodes belonging to a minus group, such that the number of edges to be cut is maximized.

In the constraint condition of the present example, the number of nodes belonging to the plus group is eight.

Such a graph cut problem is defined by Formula (6).

$${minimize}_{s} ( {\sum }_{1 \leq i \leq \frac{N}{2}} {\sum }_{1 \leq j \leq \frac{N}{2}} {s}_{i} \cdot {s}_{\frac{N}{2} + j} ) \qquad ( 6 )$$

The contents in parenthesis in Formula (6) is a graph cut function which is a quadratic function including N spin variables as a plurality of decision variables. The N spin variables correspond one-to-one to the N nodes. Further, in the graph cut problem of Formula (6), N is an even number greater than or equal to 2. s represents a vector of N spin variables. sᵢ represents the i-th element of s. s_{N/2+j} represents the (N/2)+j-th element of s. Specifically, s is defined by Formula (7).

$$s ∈ {\{ - 1 , + 1 \}}^{N} \qquad ( 7 )$$

Furthermore, in the present example, the constraint condition is defined by Formula (8).

$${\sum }_{1 \leq i \leq N} {s}_{i} = 2 \cdot K - N \qquad ( 8 )$$

In the present example, N is 12, as defined by Formula (9). K is an integer representing the number of nodes included in the positive group, and is 12, as defined by Formula (10). Therefore, in the present example, i and j are values from 1 to 12 both inclusive.

$$N = 12 \qquad ( 9 )$$

$$K = 8 \qquad ( 10 )$$

Such a graph cut problem and a minimization problem of minimizing an augmented Lagrangian function generated by converting a constraint condition into an unconstrained non-convex quadratic objective function are defined by Formula (11).

$${minimize}_{x} ( \text{} \text{?} {s}_{i} \cdot {s}_{\frac{N}{2} + j} + λ \cdot ( {\sum }_{1 \leq i \leq N} \text{?} - 2 \cdot K + N ) + \frac{μ}{2} \cdot {( {\sum }_{1 \leq i \leq N} {s}_{i} - 2 \cdot K + N )}^{2} ) \qquad ( 11 )$$

$$\text{?} \text{indicates text missing or illegible when filed}$$

The contents in parenthesis in Formula (11) represents a function obtained by adding a graph cut function and a penalty function. λ included in the penalty function is a vector including N first Lagrange coefficients. u included in the penalty function is a second Lagrange coefficient which is a scalar value.

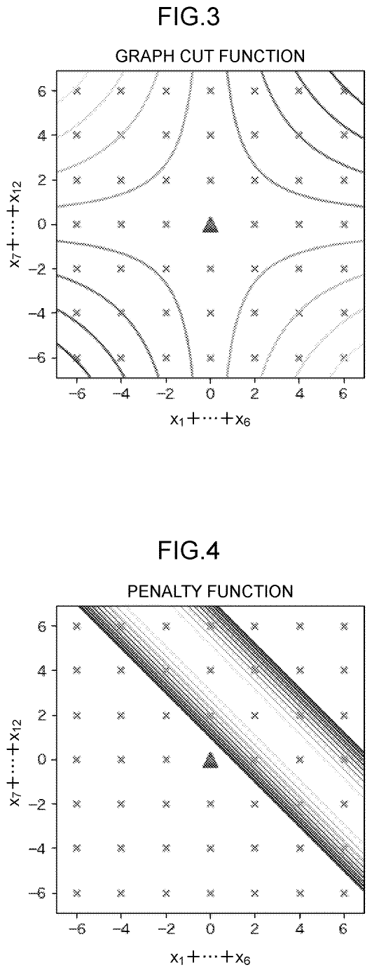

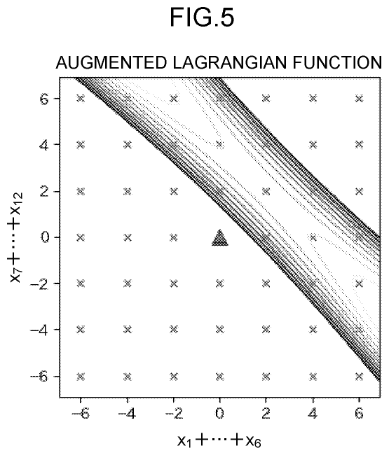

FIG. 3 is a diagram illustrating contour lines of a graph cut function in which s as N spin variables is replaced with x including N position variables. FIG. 4 is a diagram illustrating contour lines of a penalty function in which s as N spin variables is replaced with x including N position variables. FIG. 5 is a diagram illustrating contour lines of an augmented Lagrangian function in which s as N spin variables is replaced with x including N position variables.

The contour line is a curve connecting points having the same function value. In FIGS. 3, 4, and 5, the horizontal axis represents the total value of the N position variables corresponding to six nodes (the first node to the sixth node) belonging to the first group, and the vertical axis represents the total value of the N position variables corresponding to six nodes (the seventh node to the twelfth node) belonging to the second group. The same applies to drawings representing subsequent contour lines.

The augmented Lagrangian function as described above results in a normal form of a minimization problem that minimizes the non-convex quadratic objective function including the N spin variables shown in Formulas (1) to (5). The formulation unit 12 transforms the augmented Lagrangian function into a minimization problem that minimizes the non-convex quadratic objective function including such N spin variables and gives the minimization problem to the calculation apparatus 20.

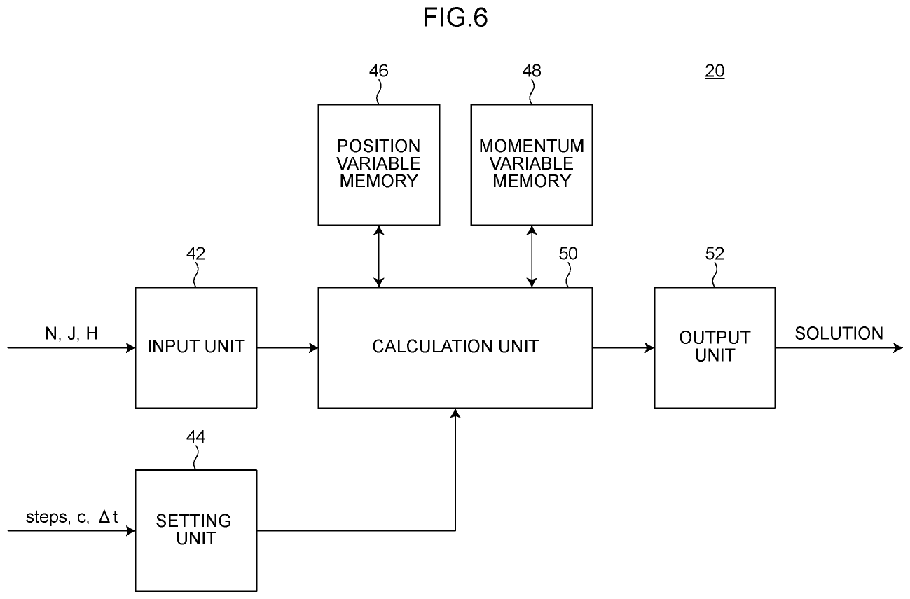

FIG. 6 is a diagram illustrating a configuration of the calculation apparatus 20.

The calculation apparatus 20 solves a minimization problem that minimizes a non-convex quadratic objective function including N spin variables by a simulated bifurcation algorithm. The calculation apparatus 20 simulates the position and the momentum of each of the N virtual particles from the initial time to the end time while reducing an adiabatic change parameter of the Hamiltonian over time for each unit time. Then, the calculation apparatus 20 outputs the minimization problem on the basis of the position of each of the N virtual particles at the end time obtained as a result of the simulation.

Here, the N spin variables correspond one-to-one to the N virtual particles.

The simulated bifurcation algorithm performs simulation using N position variables and N momentum variables.

The N position variables correspond one-to-one to the N virtual particles. Each of the N position variables represents the position of the corresponding virtual particle among the N virtual particles.

The N position variables are represented by N-dimensional vectors, for example, as defined by Formula (12). For example, each of the N position variables is a binary variable of −1 or +1. Alternatively, each of the N position variables may be a real number.

$$x ∈ {[ - 1 , + 1 ]}^{N} \qquad ( 12 )$$

The N momentum variables correspond one-to-one to the N virtual particles. Each of the N momentum variables represents the momentum of a corresponding virtual particle of the N virtual particles.

The N momentum variables are represented by N-dimensional vectors, for example, as defined by Formula (13). For example, each of the N position variables is a real number.

$$y ∈ {ℝ}^{N} \qquad ( 13 )$$

As defined by Formula (14), an adiabatic change parameter is represented as p, and is a scalar value that monotonically decreases from 1 to 0. The adiabatic change parameter is 1 at the initial time in the simulation and 0 at the end time in the simulation.

$$p = 1 \to 0 \qquad ( 14 )$$

As illustrated in FIG. 6, the calculation apparatus 20 includes an input unit 42, a setting unit 44, a position variable memory 46, a momentum variable memory 48, a calculation unit 50, and an output unit 52.

The input unit 42 acquires a minimization problem that minimizes a non-convex quadratic objective function including N spin variables. Specifically, the input unit 42 acquires a number (N) of spin variables, a coefficient matrix (J), and a coefficient vector (h). The input unit 42 gives the acquired number (N) of spin variables, coefficient matrix (J), and coefficient vector (h) to the calculation unit 50.

The setting unit 44 acquires a hyperparameter used in the simulation by the simulated bifurcation algorithm. Specifically, the setting unit 44 acquires parameters: steps, c, and Δt. The hyperparameter “Δt” represents a unit time which is a predetermined time length. The hyperparameter “steps” is an integer greater than or equal to 2 and is a value obtained by dividing the time from the initial time to the end time by the unit time. The hyperparameter “c” is a real number greater than 0. The setting unit 44 gives the acquired hyperparameter to the calculation unit 50.

The position variable memory 46 stores respective values of the N position variables. Each of the N position variables stored in the position variable memory 46 is set to an initial value at an initial time in the simulation, and thereafter, the value is updated every unit time by the calculation unit 50.

The momentum variable memory 48 stores respective values of the N momentum variables. Each of the N momentum variables stored in the momentum variable memory 48 is set to an initial value at the initial time in the simulation, and thereafter, the value is updated by the calculation unit 50 every unit time.

The calculation unit 50 simulates the position and the momentum of each of the N virtual particles from the initial time to the end time while reducing an adiabatic change parameter of the Hamiltonian over time for each unit time.

More specifically, the calculation unit 50 acquires a coefficient matrix and a coefficient vector. Subsequently, the calculation unit 50 sets the respective values of the N position variables and the respective values of the N momentum variables at the initial time in the position variable memory 46 and the momentum variable memory 48. Then, the calculation unit 50 alternately repeats momentum update processing and position update processing every unit time. In the momentum update processing, the calculation unit 50 updates the i-th momentum variable (i is an integer from 1 to N both inclusive) among the N momentum variables stored in the momentum variable memory 48 by adding, to this i-th momentum variable, a value obtained by multiplying a unit time by a value obtained by performing partial differentiation on the Hamiltonian with the i-th position variable among the N position variables stored in the position variable memory 46. In the position update processing, the calculation unit 50 updates the i-th position variable stored in the position variable memory 46 by adding, to this i-th position variable, a value obtained by multiplying a unit time by a value obtained by performing partial differentiation on the Hamiltonian with the i-th momentum variable stored in the momentum variable memory 48.

The output unit 52 calculates the value of each of the N spin variables on the basis of the position of each of the N virtual particles at the end time. Specifically, the output unit 52 calculates each value of the N spin variables by binarizing each value of the N position variables at the end time with 0 as a threshold value. Then, the output unit 52 outputs each of the calculated values of the N spin variables as a solution to the minimization problem.

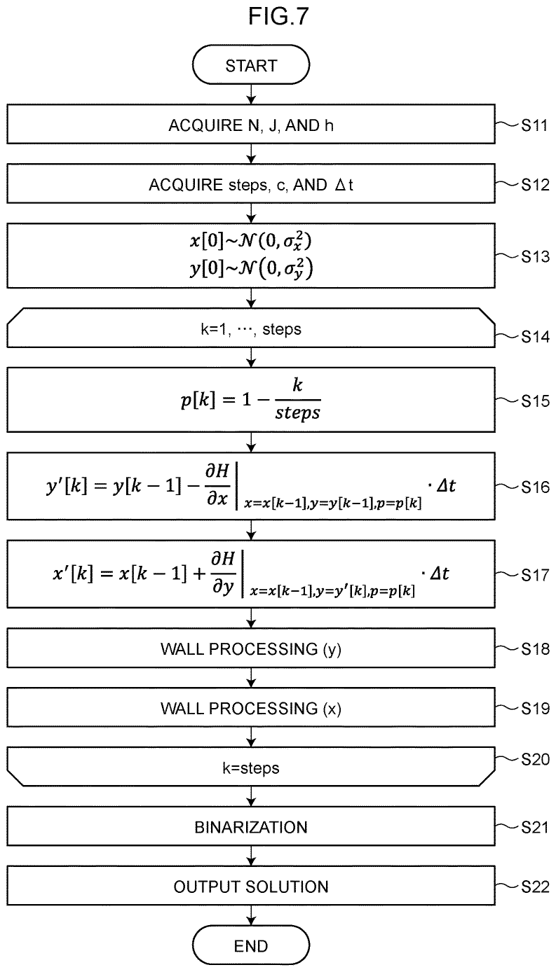

FIG. 7 is a flowchart illustrating a procedure of processing of the calculation apparatus 20. The calculation apparatus 20 executes simulation according to the simulated bifurcation algorithm in the flow illustrated in FIG. 7.

First, in S11, the calculation apparatus 20 acquires the number of spin variables (N), the coefficient matrix (J), and the coefficient vector (h) representing the minimization problem to be solved.

Subsequently, in S12, the calculation apparatus 20 acquires steps, c, and Δt which are hyperparameters.

Subsequently, in S13, the calculation apparatus 20 initializes the N position variables and the N momentum variables at the initial time by normal random numbers.

For example, the calculation apparatus 20 initializes the N position variables at the initial time, as defined by Formula (15).

$$x [ 0 ] \sim 𝒩 ( 0 , {σ}_{x}^{2} ) \qquad ( 15 )$$

x(0) is a vector representing N position variables at the initial time. N(0, σₓ²) represents random numbers whose average is 0 and whose variance accords with a normal distribution of σₓ². σₓ is a predetermined real number.

For example, the calculation apparatus 20 initializes N momentum variables at the initial time, as defined by Formula (16).

$$y [ 0 ] \sim 𝒩 ( 0 , {σ}_{y}^{2} ) \qquad ( 16 )$$

y(0) is a vector representing N momentum variables at the initial time. N(0, σ_{y}²) represents random numbers whose average value is 0 and whose variance accords with a normal distribution of σ_{y}². σ_{y} is a predetermined real number.

Subsequently, the calculation apparatus 20 repeatedly executes the processing from S15 to S19 while increasing k from 1 to steps by 1 (loop processing between S14 and S20). Note that k is a parameter representing the number of repetitions.

In S15, the calculation apparatus 20 updates an adiabatic change parameter (p). Specifically, the adiabatic change parameter (p) is calculated, as defined by Formula (17).

$$p [ k ] = 1 - \frac{k}{steps} \qquad ( 17 )$$

p(k) is an adiabatic change parameter in a case in which the number of repetitions is k. The adiabatic change parameter updated as described above decreases from 1 by a predetermined amount and becomes 0 at the end time. In the present example, p(k) decreases linearly, but may decrease non-linearly as long as p(k) decreases monotonically.

Subsequently, in S16, the calculation apparatus 20 executes momentum update processing. Subsequently, in S17, the calculation apparatus 20 executes position update processing. Specifically, the calculation apparatus 20 executes the calculation of Formula (18) in the momentum update processing in S16, and executes the calculation of Formula (19) in the position update processing in S17.

$${{y}^{′} [ k ] = y [ k - 1 ] - \frac{\partial H}{\partial x} \vert}_{x = x [ k - 1 ] , y = y [ k - 1 ] , p = p [ k ]} \cdot Δ t \qquad ( 18 )$$

$${{x}^{′} [ k ] = x [ k - 1 ] + \frac{\partial H}{\partial y} \vert}_{x = x [ k - 1 ] , y = {y}^{′} [ k ] , p = p [ k ]} \cdot Δ t \qquad ( 19 )$$

y(k−1) is a vector representing N momentum variables in a case in which the number of repetitions is (k−1). x(k−1) is a vector representing N momentum variables in a case in which the number of repetitions is (k−1). His a Hamiltonian. In addition, y′(k) is a vector representing N momentum variables in the middle of calculation in a case in which the number of repetitions is k. x′(k) is a vector representing N position variables in the middle of calculation in a case in which the number of repetitions is k.

Note that the calculation apparatus 20 may reversely execute the momentum update processing and the position update processing. That is, the calculation apparatus 20 may execute the momentum update processing after executing the position update processing. In this case, the calculation apparatus 20 executes the calculation of Formula (20) in the position update processing, and executes the calculation of Formula (21) in the momentum update processing.

$${{x}^{′} [ k ] = x [ k - 1 ] + \frac{\partial H}{\partial y} \vert}_{x = x [ k - 1 ] , y = y [ k - 1 ] , p = p [ k ]} \cdot Δ t \qquad ( 20 )$$

$${{y}^{′} [ k ] = y [ k - 1 ] - \frac{\partial H}{\partial x} \vert}_{x = {x}^{′} [ k ] , y = y [ k - 1 ] , p = p [ k ]} \cdot Δ t \qquad ( 21 )$$

Subsequently, in S18, the calculation apparatus 20 executes wall processing on the N momentum variables. In the wall processing on the N momentum variables, the calculation apparatus 20 sets, to 0, a momentum variable corresponding to a virtual particle whose absolute value of the position exceeds 1 among the N momentum variables (y′(k)) in the middle of calculation. That is, the calculation apparatus 20 changes, to 0, a momentum variable in which the corresponding position variable is smaller than −1 or the corresponding position variable is greater than +1 among the N momentum variables (y′(k)) in the middle of calculation. Specifically, the calculation apparatus 20 executes computation of Formula (22).

$$1 \leq ∀ i \leq N , {y}_{i} [ k ] = \{ \begin{matrix}0 & if {x}_{i}^{′} [ k ] ∈ [ - ∞ , - 1 ) \\ {y}_{i}^{′} [ k ] & if {x}_{i}^{′} [ k ] ∈ [ - 1 , + 1 ) \\ 0 & if {x}_{i}^{′} [ k ] ∈ [ + 1 , + ∞ )\end{matrix} \qquad ( 22 )$$

y(k) is a vector representing N momentum variables in a case in which the number of repetitions is k. Then, the calculation apparatus 20 stores the N momentum variables after the wall processing in the momentum variable memory 48 as the N momentum variables in a case in which the number of repetitions is k.

Subsequently, in S19, the calculation apparatus 20 executes wall processing on the N position variables. In the wall processing on the N position variables, the calculation apparatus 20 changes, to 1 or a value smaller than 1 in a state in which signs are the same, an absolute value of a position variable corresponding to a virtual particle whose absolute value of the position exceeds 1 among the N position variables (x′(k)) in the middle of calculation. For example, in the wall processing on the N position variables, the calculation apparatus 20 sets the position variable smaller than −1 to −1 and the position variable greater than +1 to +1 among the N position variables (x′(k)) in the middle of calculation. Specifically, the calculation apparatus 20 executes computation of Formula (23).

$$1 \leq ∀ i \leq N , {x}_{i} [ k ] = \{ \begin{matrix}- 1 & if {x}_{i}^{′} [ k ] ∈ [ - ∞ , - 1 ) \\ {x}_{i}^{′} [ k ] & if {x}_{i}^{′} [ k ] ∈ [ - 1 , + 1 ) \\ - + 1 & if {x}_{i}^{′} [ k ] ∈ [ + 1 , + ∞ )\end{matrix} \qquad ( 23 )$$

x(k) is a vector representing N position variables in a case in which the number of repetitions is k. Then, the calculation apparatus 20 stores the N position variables after the wall processing in the position variable memory 46 as the N position variables in a case in which the number of repetitions is k.

Note that the calculation apparatus 20 may not execute the processing of S18 and S19. In addition, in S18 and S19, the calculation apparatus 20 may binarize each of the N position variables to −1 or +1 with 0 as a threshold value.

In a case in which k-steps is satisfied, that is, in a case in which the simulation is performed until the end time, the calculation apparatus 20 exits the loop between S14 and S20 and proceeds to the processing in S21.

In S21, the calculation apparatus 20 calculates the respective values of the N spin variables by binarizing the respective values of the N position variables at the end time with 0 as a threshold value. Specifically, the calculation of Formula (24) is executed.

$$s = sgn ( x [ steps ] ) \qquad ( 24 )$$

Subsequently, in S22, the calculation apparatus 20 outputs a vector representing the N spin variables as a solution to a minimization problem. When the processing in S22 is completed, the calculation apparatus 20 ends this flow.

Here, H₀, which is a conventional Hamiltonian used in the simulation of the conventional simulated bifurcation algorithm, is defined by, for example, Formula (25).

$${H}_{0} ( x , y ; p ; steps , c , Δ t ) = c \cdot ( \frac{1}{2} {x}^{T} \cdot J \cdot x + {h}^{T} \cdot x ) + \frac{p}{2} \cdot {‖ x ‖}^{2} + \frac{1}{2} \cdot {‖ y ‖}^{2} \qquad ( 25 )$$

x is a vector representing N position variables. y is a vector representing N momentum variables. x^{T} is a transposed vector of x.

∥x∥ is a norm of x. ∥y∥ is a norm of y. h^{T} is a transposed vector of h.

p is an adiabatic change parameter. p is 1 at the initial time and is 0 at the end time, and decreases every unit time from the initial time to the end time.

The partial derivative of the momentum variable with respect to such a conventional Hamiltonian is defined by Formula (26).

$$\frac{\partial H}{\partial y} = ( c \cdot ( J \cdot x + h ) + p \cdot x ) \qquad ( 26 )$$

The partial derivative of the position variable with respect to such a conventional Hamiltonian is defined by Formula (27).

$$\frac{\partial H}{\partial y} = y \qquad ( 27 )$$

Next, a stable point (x_{stable}) and an energy difference (ΔE) at the initial time will be described.

The stable point (x_{stable}) represents a vector representing N position variables in which each of the N momentum variables is 0, each of the partial derivatives of the N position variables with respect to the Hamiltonian is 0, and each of the partial derivatives of the N momentum variables with respect to the Hamiltonian is 0.

Therefore, at the initial time, the partial derivative of the Hamiltonian with respect to the vector of the position variable is defined by Formula (28). Furthermore, at the initial time, the partial derivative of the Hamiltonian with respect to the vector of the momentum variable is defined by Formula (29).

$${\frac{\partial H}{\partial x} \vert}_{x = {x}_{stable} , y = 0 ; p = 1} = 0 \qquad ( 28 )$$

$${\frac{\partial H}{\partial y} \vert}_{x = {x}_{stable} , y = 0 ; p = 1} = 0 \qquad ( 29 )$$

The energy difference (ΔE) represents a difference between initial energy of the Hamiltonian and stable point energy at the initial time of the Hamiltonian.

The initial energy of the Hamiltonian is energy represented by the Hamiltonian at the initial time in an initial state in which N position variables are initialized and each of the N momentum variables is set to 0. The stable point energy at the initial time of the Hamiltonian is energy represented by the Hamiltonian at the initial time in a stable state in which the N position variables are stable points and each of the N momentum variables is 0.

As defined by Formula (30), the energy difference (ΔE) is greater than or equal to 0.

$$Δ E \geq 0 \qquad ( 30 )$$

In addition, the energy difference (ΔE) is defined by Formula (31).

$$Δ E = H ( x = x [ 0 ] , y = y [ 0 ] ; p = 1 ) - H ( x = {x}_{stable} ( c ) , y = 0 ; p = 1 ) \qquad ( 31 )$$

In a case in which an average value of the positions of the N position variables at the initial time is 0, the energy difference (ΔE) is defined by Formula (32).

$$Δ E ≃ - H ( x = {x}_{stable} ( c ) , y = 0 ; P = 1 ) \qquad ( 32 )$$

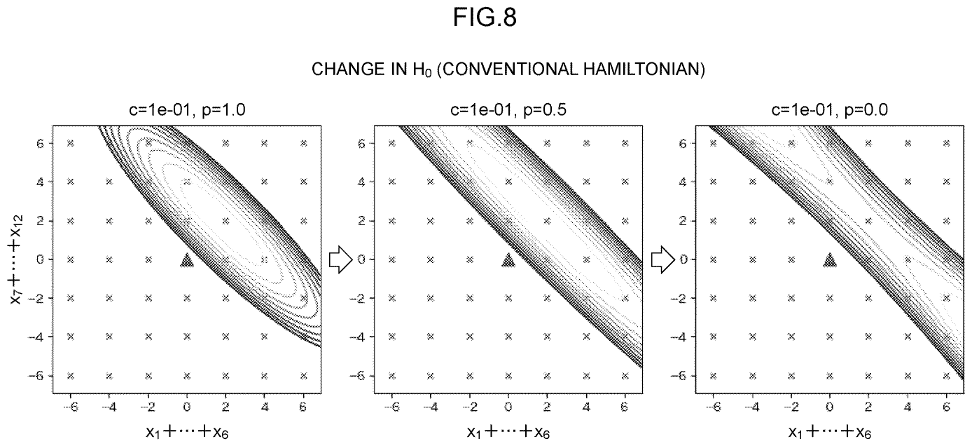

FIG. 8 is a diagram illustrating a change in contour lines of the conventional Hamiltonian (H₀) in a case in which the minimization problem is a problem of minimizing the augmented Lagrangian function defined by Formula (11) and c=1×10⁻¹.

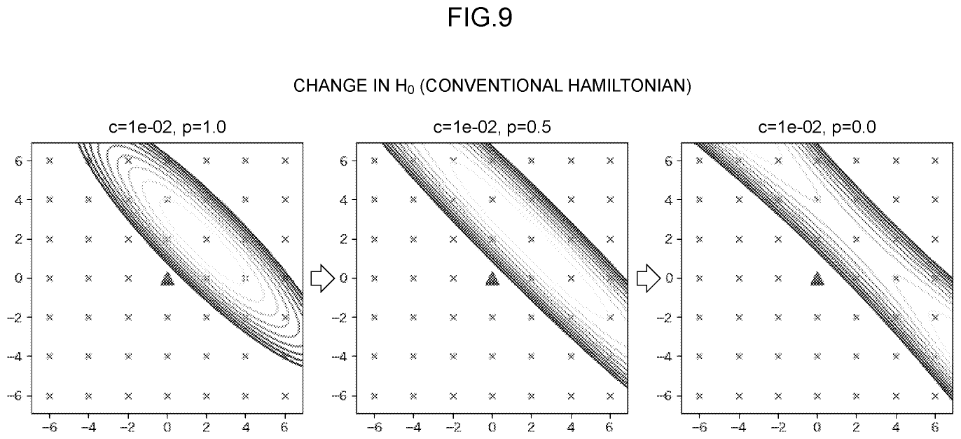

FIG. 9 is a diagram illustrating a change in contour lines of the conventional Hamiltonian (H₀) in a case in which the minimization problem is a problem of minimizing the augmented Lagrangian function defined by Formula (11) and c=1×10⁻².

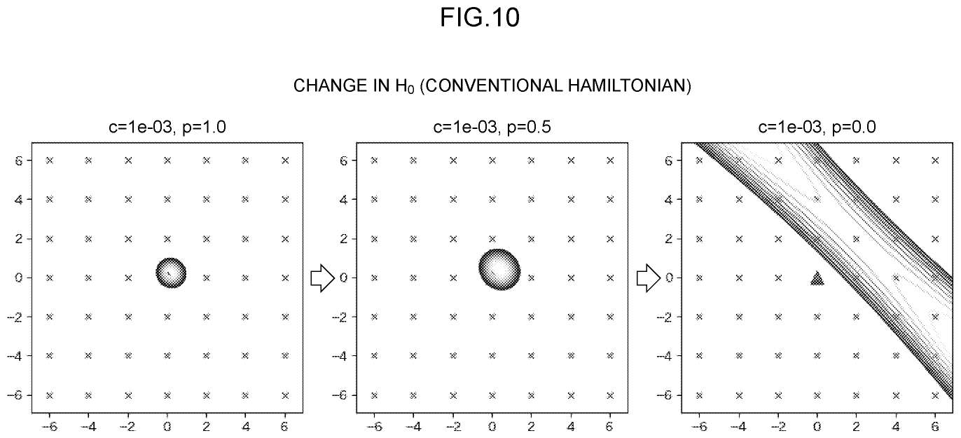

FIG. 10 is a diagram illustrating a change in contour lines of the conventional Hamiltonian (H₀) in a case in which the minimization problem is a problem of minimizing the augmented Lagrangian function defined by Formula (11) and c=1×10⁻³.

A triangle in the drawing represents an average value of the N position variables at the initial time.

The energy difference (ΔE) increases as c increases. The N virtual particles in the initial state become unstable as the energy difference (ΔE) increases. When the initial state of the N virtual particles is unstable, the time until motion is stabilized increases. Therefore, when the initial state is unstable, the calculation apparatus 20 requires a longer simulation time to obtain an accurate solution.

In addition, in the conventional Hamiltonian (H₀), as c is smaller, a shape difference between contour maps of the initial time and the end time is larger. In a case in which the shape difference between the contour maps of the initial time and the end time is large, the motion of the N virtual particles becomes unstable between the initial time and the end time. Therefore, when c is too small, the calculation apparatus 20 requires a longer simulation time to obtain an accurate solution.

In a case in which such a conventional Hamiltonian (H₀) is used, the calculation apparatus 20 encounters a problem that is difficult to solve. Specifically, in a case in which the conventional Hamiltonian (H₀) is used, it is difficult for the calculation apparatus 20 to solve a problem having h larger than J. The reason why it is difficult to solve such a problem is considered that the initial state is unstable.

For example, it is assumed that c is set such that Formula (33) and Formula (34) are satisfied.

$$‖ c \cdot H ‖ ≪ 1 \qquad ( 33 )$$

$$‖ c \cdot J ‖ ≪ 1 \qquad ( 34 )$$

A stable point at y=0 in the conventional Hamiltonian (H₀) is calculated as a stable point function (x_{0,stable}(c)) having c as a variable.

A partial derivative of x of the conventional Hamiltonian (H₀) is defined by Formula (35).

$${\frac{\partial H}{\partial x} \vert}_{x = {x}_{0 , stable} ( c ) , y = 0 ; p = 1} = 0 \qquad ( 35 )$$

Formula (35) is transformed as defined by Formula (36) from Formula (26), Formula (27), and p=1.

$$c \cdot ( J \cdot {x}_{0 , stable} ( c ) + h ) + {x}_{0 , stable} ( c ) = 0 \qquad ( 36 )$$

When the N-by-N identity matrix is represented as I, Formula (36) is transformed as defined by Formula (37).

$$c \cdot h + ( c \cdot J + I ) \cdot {x}_{0 , stable} ( c ) = 0 \qquad ( 37 )$$

From Formula (37), the stable point function (x_{0,stable}(c)) representing a stable point at y=0 in the conventional Hamiltonian (H₀) is defined by Formula (38).

$${x}_{0 , stable} ( c ) = {( c \cdot J + I )}^{- 1} ( - c \cdot h ) \qquad ( 38 )$$

An energy difference (ΔE₀) between the initial energy of the conventional Hamiltonian and the stable point energy at the initial time of the conventional Hamiltonian is greater than or equal to 0, as defined by Formula (39).

$$Δ {E}_{0} \geq 0 \qquad ( 39 )$$

Then, the energy difference (ΔE₀) of the conventional Hamiltonian is defined by Formula (40).

$$Δ {E}_{0} = {H}_{0} ( x = x [ 0 ] , y = y [ 0 ] ; p = 1 ) - {H}_{0} ( x = {x}_{0 , stable} ( c ) , y = 0 ; p = 1 ) ≃ - {H}_{0} ( x = {x}_{0 , stable} ( c ) , y = 0 ; p = 1 ) = \frac{{c}^{2}}{2} \cdot {h}^{T} \cdot {( c \cdot J + I )}^{- 1} \cdot h ≃ \frac{{c}^{2} \cdot {\vert h \vert}^{2}}{2 \cdot \vert c \cdot J + I \vert} \qquad ( 40 )$$

In the conventional Hamiltonian defined by Formula (40), a problem in which h is larger than J is ΔE₀>>0, and the initial state tends to be unstable. On the other hand, in a case in which c is made extremely small in the conventional Hamiltonian, the calculation apparatus 20 needs to set a large step in order to maintain solution accuracy, and the amount of calculation increases.

### Novel Hamiltonian and Novel Initial State

The present inventor has found a novel Hamiltonian and a novel initial state in which the initial state is not unstable and the amount of calculation is not increased.

The novel Hamiltonian and the novel initial state have the following features.

(1) The novel Hamiltonian can calculate a stable point which is a value of each of the N position variables in which each of the N momentum variables is 0 at the initial time. That is, the novel Hamiltonian can calculate the stable point which is the value of each of the N position variables in which each of the N momentum variables is 0 when the adiabatic change parameter is 1.

(2) Each of the N position variables at the initial time is a value obtained by adding a normal random number to the stable point at the initial time.

(3) The novel Hamiltonian is the same as Formula (41) at the end time.

$${H}_{0} ( x , y ; p ; staps , c , Δ t ) = c \cdot ( \frac{1}{2} {x}^{T} \cdot J \cdot x + {h}^{T} \cdot x ) + \frac{1}{2} \cdot {‖ y ‖}^{2} \qquad ( 41 )$$

Formula (41) is the same as Formula in which p=0 is substituted into H₀, which is a conventional Hamiltonian used in the simulation of the conventional simulated bifurcation algorithm. Therefore, the novel Hamiltonian is the same as H₀, which is the conventional Hamiltonian, at the end time, that is, in a case in which the adiabatic change parameter is 0.

Hereinafter, a first example to a fourth example of the novel Hamiltonian and the novel initial state will be specifically described.

### First Example

In the first example, the N position variables at the initial time are defined by Formula (42).

$$x [ 0 ] ∼ 𝒩 ( 0 , {σ}_{x}^{2} ) \qquad ( 42 )$$

x(0) represents x at the initial time. N(0, σₓ²) represents random numbers whose average is 0 and whose variance accords with a normal distribution of σₓ².

Furthermore, in the first example, the N momentum variables at the initial time are defined by Formula (43).

$$y [ 0 ] ∼ 𝒩 ( 0 , {σ}_{y}^{2} ) \qquad ( 43 )$$

y(0) represents y at the initial time. N(0, σ_{y}²) represents random numbers whose average is 0 and whose variance accords with a normal distribution of σ_{y}².

That is, in the first example, in the initial state of the N virtual particles, the average value of the energy becomes a value close to 0.

Furthermore, the Hamiltonian (H₁) in the first example is defined by Formula (44).

$${H}_{1} ( x , y ; p ; staps , c , Δ t ) = ( 1 - p ) \cdot c \cdot ( \frac{1}{2} {x}^{T} \cdot J \cdot x + {h}^{T} \cdot x ) + \frac{p}{2} \cdot {‖ x ‖}^{2} + \frac{1}{2} \cdot {‖ y ‖}^{2} \qquad ( 44 )$$

The Hamiltonian (H₁) in the first example is obtained by multiplying the coefficient c by (1−p). Therefore, in the Hamiltonian (H₁) in the first example, the term including J and the term including h become 0 at the initial time (p=1).

In addition, a stable point (x_{1,stable}) in the first example is capable of being calculated, as defined by Formula (45), and is 0.

$${x}_{1 , stable} = \frac{- 0 \cdot c \cdot h}{0 \cdot c \cdot J + I} = 0 \qquad ( 45 )$$

Since the stable point (x_{1,stable}) in the first example is 0, the stable point matches the average value of the N position variables at the initial time.

In addition, an energy difference (ΔE₁) in the first example is greater than or equal to 0 and sufficiently smaller than 1, as defined by Formula (46).

$$0 \leq Δ {E}_{1} ≪ 1 \qquad ( 46 )$$

By executing the simulation using the Hamiltonian (H₁) in the first example and the initial states of the N virtual particles in the first example, the initial states of the N virtual particles are stabilized, and the calculation apparatus 20 can calculate an accurate solution with a practical calculation amount.

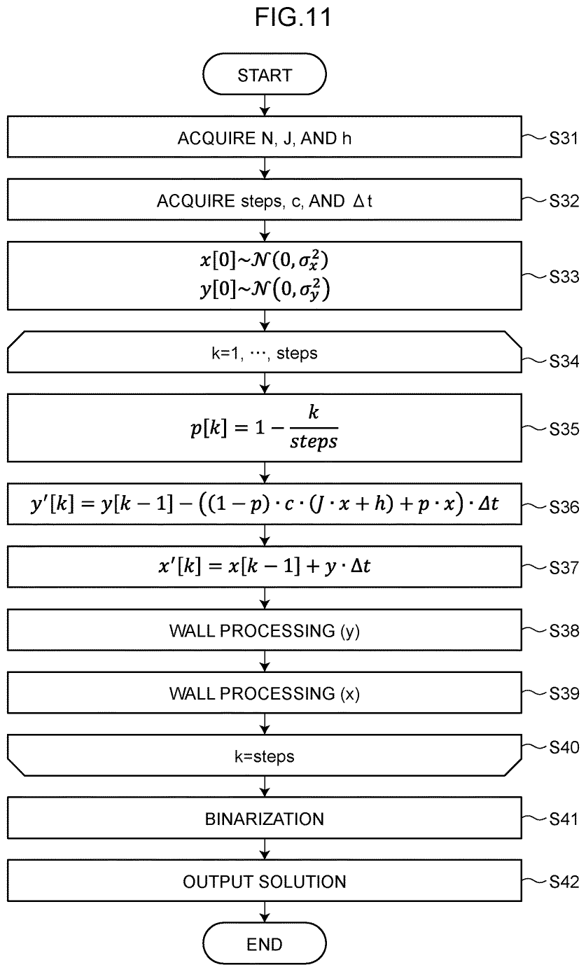

FIG. 11 is a flowchart illustrating a procedure of processing of the calculation apparatus 20 in the first example. The calculation apparatus 20 executes simulation according to the simulated bifurcation algorithm in the flow illustrated in FIG. 11.

First, in S31, the calculation apparatus 20 acquires the number of spin variables (N), the coefficient matrix (J), and the coefficient vector (h).

Subsequently, in S32, the calculation apparatus 20 acquires steps, c, and Δt.

Subsequently, in S33, the calculation apparatus 20 initializes the N position variables at the initial time by normal random numbers whose average is 0 and whose variance accords with a normal distribution of σₓ², as defined by Formula (47).

$$y [ 0 ] ∼ 𝒩 ( 0 , {σ}_{x}^{2} ) \qquad ( 47 )$$

In addition, the calculation apparatus 20 initializes the N momentum variables at the initial time by normal random numbers whose average is 0 and whose variance accords with a normal distribution of σ_{y}², as defined by Formula (48).

$$y [ 0 ] ∼ 𝒩 ( 0 , {σ}_{y}^{2} ) \qquad ( 48 )$$

Subsequently, the calculation apparatus 20 repeatedly executes the processing from S35 to S39 while increasing k from 1 to steps by 1 (loop processing between S34 and S40).

In S35, the calculation apparatus 20 calculates an adiabatic change parameter (p), as defined by Formula (49).

$$p [ k ] = 1 - \frac{k}{steps} \qquad ( 49 )$$

Subsequently, in S36, the calculation apparatus 20 executes momentum update processing. Subsequently, in S37, the calculation apparatus 20 executes position update processing. In the first example, the calculation apparatus 20 executes the calculation of Formula (50) in the momentum update processing in S36, and executes the calculation of Formula (51) in the position update processing in S37.

$${{y}^{′} [ k ] = y [ k - 1 ] - \frac{\partial {H}_{1}}{\partial x} \vert}_{x = x [ k - 1 ] , y = y [ k - 1 ] , p = p [ k ]} \cdot Δ t \qquad ( 50 )$$

$${{x}^{′} [ k ] = x [ k - 1 ] + \frac{\partial {H}_{1}}{\partial y} \vert}_{x = x [ k - 1 ] , y = {y}^{′} [ k ] , p = p [ k ]} \cdot Δ t \qquad ( 51 )$$

Specifically, Formula (50) is defined by Formula (52).

$${y}^{′} [ k ] = y [ k - 1 ] - ( ( 1 - p ) \cdot c \cdot ( J \cdot x + h ) + p \cdot x ) \cdot Δ t \qquad ( 52 )$$

Specifically, Formula (51) is defined by Formula (53).

$${x}^{′} [ k ] = x [ k - 1 ] + y \cdot Δ t \qquad ( 53 )$$

Note that the calculation apparatus 20 may reversely execute the momentum update processing and the position update processing. That is, the calculation apparatus 20 may execute the momentum update processing after executing the position update processing. In this case, the calculation apparatus 20 executes the calculation of Formula (54) in the position update processing, and executes the calculation of Formula (55) in the momentum update processing.

$${{x}^{′} [ k ] = x [ k - 1 ] - \frac{\partial {H}_{1}}{\partial y} \vert}_{x = x [ k - 1 ] , y = y [ k - 1 ] , p = p [ k ]} \cdot Δ t \qquad ( 54 )$$

$${{y}^{′} [ k ] = y [ k - 1 ] - \frac{\partial {H}_{1}}{\partial x} \vert}_{x = {x}^{′} [ k ] , y = y [ k - 1 ] , p = p [ k ]} \cdot Δ t \qquad ( 55 )$$

Subsequently, in S38, the calculation apparatus 20 executes wall processing on the N momentum variables by the calculation of Formula (56).

$$1 \leq ∀ i \leq N , \qquad ( 56 )$$

$${y}_{i} [ k ] = \{ \begin{matrix}0 & if {x}_{i}^{′} [ k ] ∈ [ - ∞ , - 1 ) \\ {y}_{i}^{′} [ k ] & if {x}_{i}^{′} [ k ] ∈ [ - 1 , + 1 ] \\ 0 & if {x}_{i}^{′} [ k ] ∈ ( + 1 , + ∞ ]\end{matrix}$$

The calculation apparatus 20 stores the N momentum variables after the wall processing in the momentum variable memory 48 as the N momentum variables in a case in which the number of repetitions is k.

Subsequently, in S39, the calculation apparatus 20 executes the wall processing on the N position variables by the calculation of Formula (57).

$$1 \leq ∀ i \leq N , \qquad ( 57 )$$

$${x}_{i} [ k ] = \{ \begin{matrix}- 1 & if {x}_{i}^{′} [ k ] ∈ [ - ∞ , - 1 ) \\ {x}_{i}^{′} [ k ] & if {x}_{i}^{′} [ k ] ∈ [ - 1 , + 1 ] \\ + 1 & if {x}_{i}^{′} [ k ] ∈ ( + 1 , + ∞ ]\end{matrix}$$

The calculation apparatus 20 stores the N position variables after the wall processing in the position variable memory 46 as the N position variables in a case in which the number of repetitions is k.

Note that the calculation apparatus 20 may not execute the processing of S38 and S39. In addition, in S39, the calculation apparatus 20 may binarize each of the N position variables to −1 or +1 with 0 as a threshold value.

In a case in which k=steps is satisfied, that is, in a case in which the simulation is performed until the end time, the calculation apparatus 20 exits the loop between S34 and S40 and proceeds to the processing in S41.

In S41, the calculation apparatus 20 calculates the respective values of the N spin variables by binarizing the respective values of the N position variables at the end time with 0 as a threshold value.

Subsequently, in S42, the calculation apparatus 20 outputs a vector representing the N spin variables as a solution to a minimization problem. When the processing in S42 is completed, the calculation apparatus 20 ends this flow.

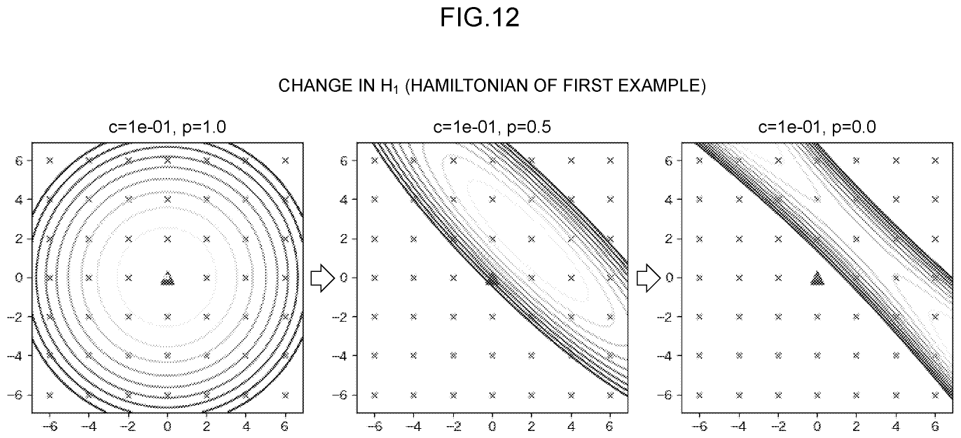

FIG. 12 is a diagram illustrating a change in contour lines of the conventional Hamiltonian (H₁) of the first example in a case in which the minimization problem is a problem of minimizing the augmented Lagrangian function defined by Formula (11) and c=1×10⁻¹.

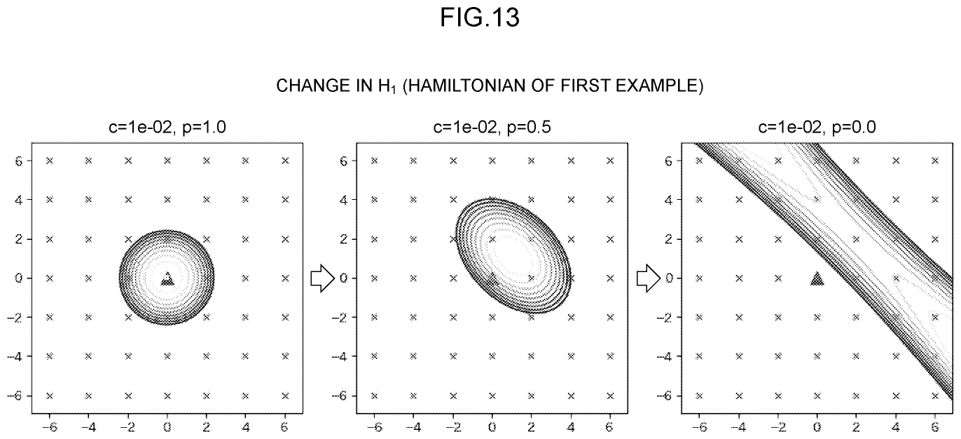

FIG. 13 is a diagram illustrating a change in contour lines of the conventional Hamiltonian (H₁) of the first example in a case in which the minimization problem is a problem of minimizing the augmented Lagrangian function defined by Formula (11) and c=1×10⁻².

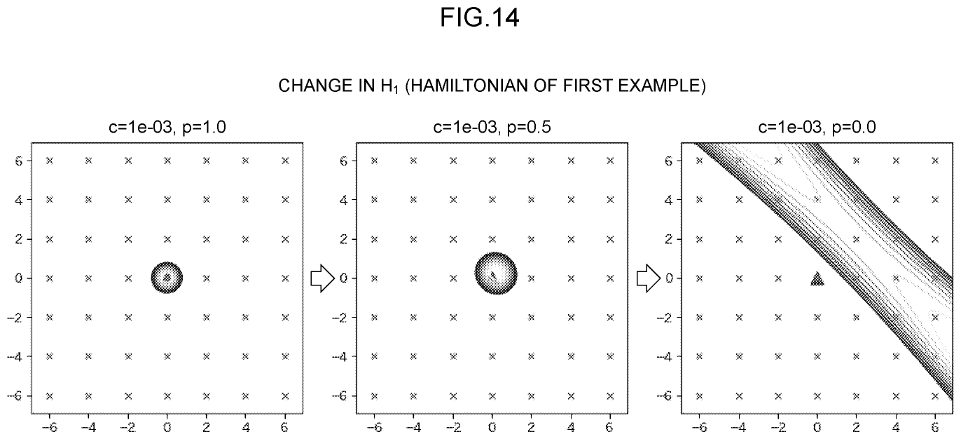

FIG. 14 is a diagram illustrating a change in contour lines of the conventional Hamiltonian (H₁) of the first example in a case in which the minimization problem is a problem of minimizing the augmented Lagrangian function defined by Formula (11) and c=1×10⁻³.

As indicated by contour lines of the Hamiltonian (H₁) of the first example in the case of p=1.0 in FIGS. 12 to 14, the energy difference (ΔE₁) in the first example is substantially 0 regardless of the magnitude of c. As a result, the calculation apparatus 20 according to the first example can stabilize the initial states of the N virtual particles and calculate an accurate solution with a practical calculation amount.

### Second Example

In the second example, the N position variables at the initial time are defined by Formula (58).

$$x [ 0 ] ∼ 𝒩 ( 0 , {σ}_{x}^{2} ) \qquad ( 58 )$$

Furthermore, in the second example, the N momentum variables at the initial time are defined by Formula (59).

$$y [ 0 ] ∼ 𝒩 ( 0 , {σ}_{y}^{2} ) \qquad ( 59 )$$

That is, in the second example, in the initial state of the N virtual particles, the average value of the energy becomes a value close to 0.

Furthermore, the Hamiltonian (H₂) in the second example is defined by Formula (60).

$${H}_{2} ( x , y ; p ; steps , c , Δ t ) = c \cdot ( \frac{1}{2} {x}^{T} \cdot J \cdot x + ( 1 - p ) \cdot {h}^{T} \cdot x ) + \frac{p}{2} \cdot {‖ x ‖}^{2} + \frac{1}{2} \cdot {‖ y ‖}^{2} \qquad ( 60 )$$

The Hamiltonian (H₂) in the second example is obtained by multiplying a term including h by (1−p). Therefore, in the Hamiltonian (H₂) in the second example, the term including h becomes 0 at the initial time (p=1).

In addition, a stable point (x_{2,stable}) in the second example is capable of being calculated, as defined by Formula (61), and is 0.

$${x}_{2 , stable} = \frac{- 0 \cdot c \cdot h}{c \cdot J + I} = 0 \qquad ( 61 )$$

Since the stable point (x_{2,stable}) in the second example is 0, the stable point matches the average value of the N position variables at the initial time.

In addition, an energy difference (ΔE₂) in the second example is greater than or equal to 0 and sufficiently smaller than 1, as defined by Formula (62).

$$0 \leq Δ {E}_{2} ≪ 1 \qquad ( 62 )$$

By executing the simulation using the Hamiltonian (H₂) in the second example and the initial states of the N virtual particles in the second example, the initial states of the N virtual particles are stabilized, and the calculation apparatus 20 can calculate an accurate solution with a practical calculation amount.

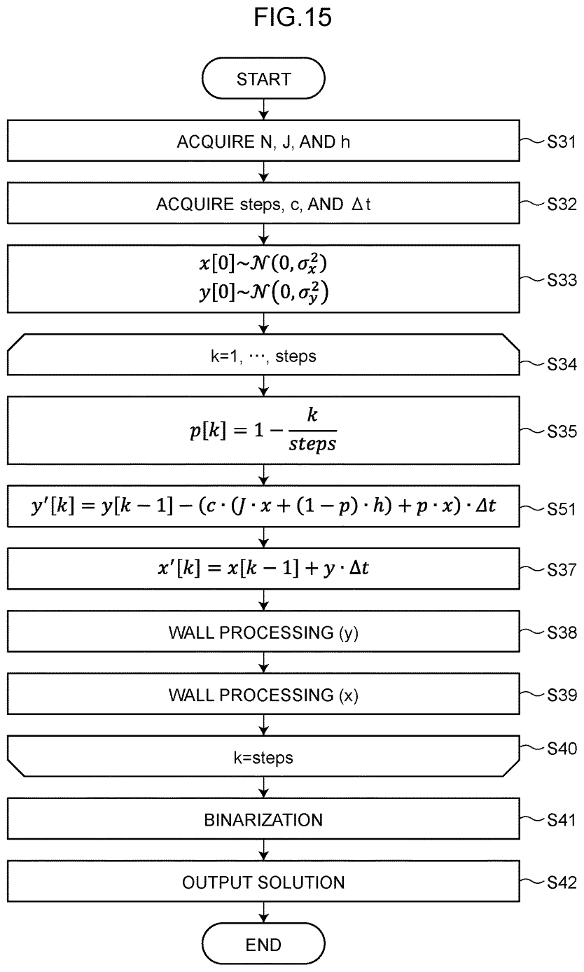

FIG. 15 is a flowchart illustrating a procedure of processing of the calculation apparatus 20 in the second example. The calculation apparatus 20 executes simulation according to the simulated bifurcation algorithm in the flow illustrated in FIG. 15. Note that, regarding the processing of the calculation apparatus 20 according to the second example, differences from the calculation apparatus 20 of the first example illustrated in FIG. 11 will be described, and description of the matching points will be omitted.

Following the processing in S35, the calculation apparatus 20 executes momentum update processing in S51. In the second example, the calculation apparatus 20 executes the calculation of Formula (63) in the momentum update processing in S51.

$${{y}^{′} [ k ] = y [ k - 1 ] - \frac{\partial {H}_{2}}{\partial x} \vert}_{x = x [ k - 1 ] , y = y [ k - 1 ] , p = p [ k ]} \cdot Δ t \qquad ( 63 )$$

Specifically, Formula (63) is defined by Formula (64).

$${y}^{′} [ k ] = y [ k - 1 ] - ( c \cdot ( J \cdot x + ( 1 - p ) \cdot h ) + p \cdot x ) \cdot Δ t \qquad ( 64 )$$

Following the processing in S51, the calculation apparatus 20 executes position update processing in S37. Note that the calculation apparatus 20 may execute the momentum update processing after executing the position update processing. In this case, the calculation apparatus 20 executes the calculation of Formula (65) in the position update processing, and executes the calculation of Formula (66) in the momentum update processing.

$${{x}^{′} [ k ] = x [ k - 1 ] - \frac{\partial {H}_{2}}{\partial y} \vert}_{x = x [ k - 1 ] , y = y [ k - 1 ] , p = p [ k ]} \cdot Δ t \qquad ( 65 )$$

$${{y}^{′} [ k ] = y [ k - 1 ] - \frac{\partial {H}_{2}}{\partial x} \vert}_{x = {x}^{′} [ k ] , y = y [ k - 1 ] , p = p [ k ]} \cdot Δ t \qquad ( 66 )$$

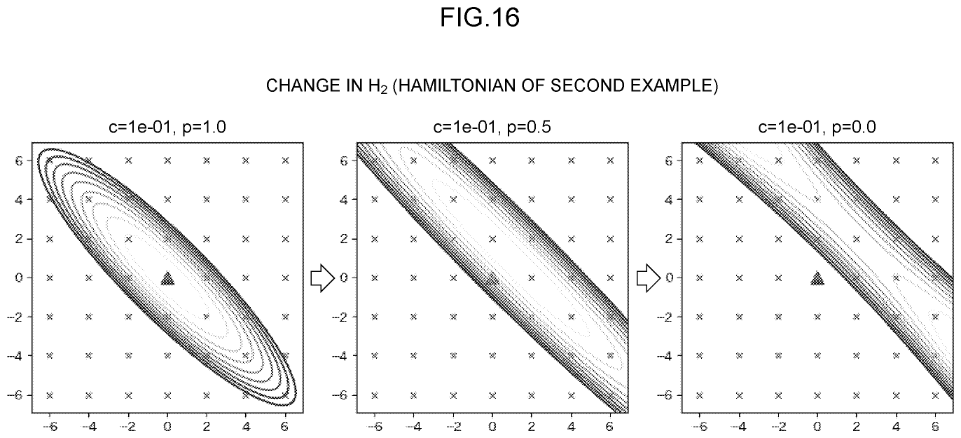

FIG. 16 is a diagram illustrating a change in contour lines of the Hamiltonian (H₂) of the second example in a case in which the minimization problem is a problem of minimizing the augmented Lagrangian function defined by Formula (11) and c=1×10⁻¹.

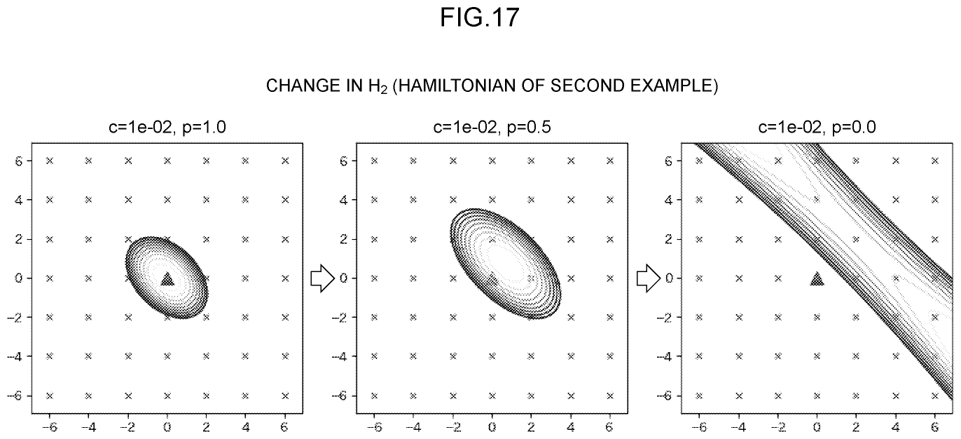

FIG. 17 is a diagram illustrating a change in contour lines of the Hamiltonian (H₂) of the second example in a case in which the minimization problem is a problem of minimizing the augmented Lagrangian function defined by Formula (11) and c=1×10⁻².

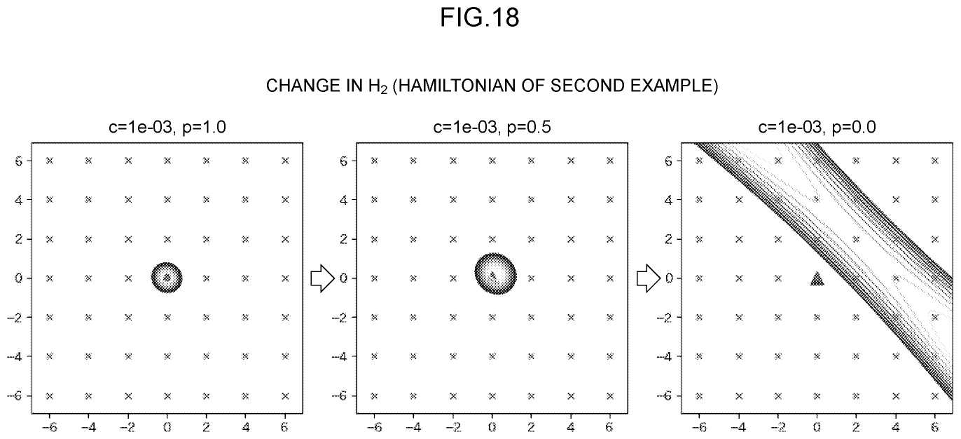

FIG. 18 is a diagram illustrating a change in contour lines of the Hamiltonian (H₂) of the second example in a case in which the minimization problem is a problem of minimizing the augmented Lagrangian function defined by Formula (11) and c=1×10⁻³.

As indicated by contour lines of the Hamiltonian (H₂) of the second example in the case of p=1.0 in FIGS. 16 to 18, the energy difference (ΔE₂) in the second example is substantially 0 regardless of the magnitude of c. In addition, in the Hamiltonian (H₂) of the second example, as c is larger, a shape difference between contour maps of the initial time and the end time is smaller. Therefore, as c is larger, the Hamiltonian (H₂) of the second example can stabilize the motion of the N virtual particles between the initial time and the end time. Therefore, the calculation apparatus 20 can shorten the simulation time until an accurate solution is obtained. As a result, the calculation apparatus 20 according to the second example can stabilize the initial states of the N virtual particles and calculate an accurate solution with a practical calculation amount.

### Third Example

In the third example, the N position variables at the initial time are defined by Formula (67).

$$x [ 0 ] ∼ 𝒩 ( {x}_{3 , stable} ( c ) , {σ}_{x}^{2} ) \qquad ( 67 )$$

Furthermore, in the third example, the N momentum variables at the initial time are defined by Formula (68).

$$y [ 0 ] ∼ 𝒩 ( 0 , {σ}_{y}^{2} ) \qquad ( 68 )$$

N(x_{3,stable}(c), σₓ²) represents random numbers whose average is x_{3,stable}(c) and whose variance accords with a normal distribution of σₓ². x_{3,stable}(c) is a function representing a stable point having c as a variable. That is, in the third example, in the initial state of the N virtual particles, the average value of the energy becomes a value close to the stable point (x_{3,stable}(c)) of the third example.

Furthermore, the Hamiltonian (H₃) in the third example is defined by Formula (69).

$${H}_{3} ( x , y ; p ; steps , c , Δ t ) = c \cdot ( \frac{1}{2} {x}^{T} \cdot J \cdot x + {h}^{T} \cdot x ) + \frac{p}{2} \cdot {‖ x ‖}^{2} + \frac{1}{2} \cdot {‖ y ‖}^{2} \qquad ( 69 )$$

The Hamiltonian (H₃) in the third example is the same as the conventional Hamiltonian (H₀).

In addition, the stable point (x_{3,stable}(c)) in the third example is capable of being calculated, as defined by Formula (70), and is (−c·h/(c·J+I)).

$${x}_{3 , stable} ( c ) = \frac{- c \cdot h}{c \cdot J + I} \qquad ( 70 )$$

However, since Formula (70) includes calculation to calculate an inverse matrix, the calculation apparatus 20 may require a large amount of calculation depending on the size of J.

Since the stable point (x_{3,stable}(c)) in the third example is (—c·h/(c·J+I)), the stable point matches the average value of the N position variables at the initial time.

In addition, an energy difference (ΔE₃) in the third example is greater than or equal to 0 and sufficiently smaller than 1, as defined by Formula (71).

$$0 \leq Δ {E}_{3} ≪ 1 \qquad ( 71 )$$

By executing the simulation using the Hamiltonian (H₃) in the third example and the initial states of the N virtual particles in the third example, the initial states of the N virtual particles are stabilized, and the calculation apparatus 20 can calculate an accurate solution with a practical calculation amount.

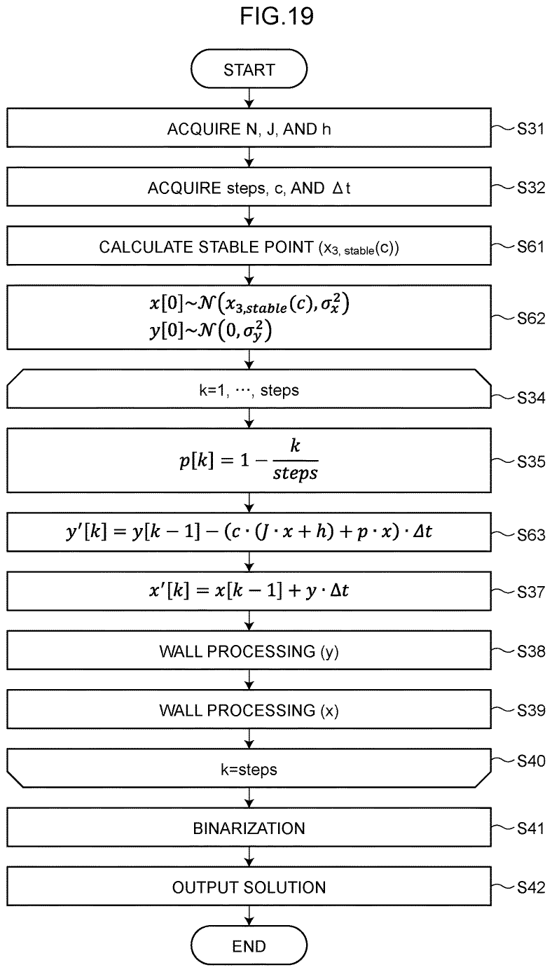

FIG. 19 is a flowchart illustrating a procedure of processing of the calculation apparatus 20 in the third example. The calculation apparatus 20 executes simulation according to the simulated bifurcation algorithm in the flow illustrated in FIG. 19. Note that, regarding the processing of the calculation apparatus 20 according to the third example, differences from the calculation apparatus 20 of the first example illustrated in FIG. 11 will be described, and description of the matching points will be omitted.

Subsequent to S32, in S61, the calculation apparatus 20 calculates the stable point (x_{3,stable}(c)). Specifically, the calculation apparatus 20 calculates (−c·h/(c·J+I)).

Subsequently, in S62, the calculation apparatus 20 initializes the N position variables at the initial time by normal random numbers whose average is x_{3,stable}(c) and whose variance accords with a normal distribution of σₓ², as defined by Formula (72).

$$x [ 0 ] ∼ 𝒩 ( {x}_{3 , stable} ( c ) , {σ}_{x}^{2} ) \qquad ( 72 )$$

In addition, the calculation apparatus 20 initializes the N momentum variables at the initial time by normal random numbers whose average is 0 and whose variance accords with a normal distribution of σ_{y}², as defined by Formula (73).

$$y [ 0 ] ∼ 𝒩 ( 0 , {σ}_{y}^{2} ) \qquad ( 73 )$$

After completing S62, the calculation apparatus 20 proceeds to the processing in S34.

Following the processing in S35, the calculation apparatus 20 executes momentum update processing in S63. In the third example, the calculation apparatus 20 executes the calculation of Formula (74) in the momentum update processing in S63.

$${{y}^{′} [ k ] = y [ k - 1 ] - \frac{\partial {H}_{3}}{\partial x} \vert}_{x = x [ k - 1 ] , y = y [ k - 1 ] , p = p [ k ]} \cdot Δ t \qquad ( 74 )$$

Specifically, Formula (74) is defined by Formula (75).

$${y}^{′} [ k ] = y [ k - 1 ] - ( c \cdot ( J \cdot x + h ) + p \cdot x ) \cdot Δ t \qquad ( 75 )$$

Following the processing in S63, the calculation apparatus 20 executes position update processing in S37. Note that the calculation apparatus 20 may execute the momentum update processing after executing the position update processing. In this case, the calculation apparatus 20 executes the calculation of Formula (76) in the position update processing, and executes the calculation of Formula (77) in the momentum update processing.

$${x}^{′} [ k ] = x [ k - 1 ] + \frac{\partial {H}_{3}}{\partial y} {\vert}_{x = x [ k - 1 ] , y = y [ k - 1 ] , p = p [ k ]} \cdot Δ t \qquad ( 76 )$$

$${y}^{′} [ k ] = y [ k - 1 ] - \frac{\partial {H}_{3}}{\partial x} {\vert}_{x = x ′ [ k - 1 ] , y = y [ k - 1 ] , p = p [ k ]} \cdot Δ t \qquad ( 77 )$$

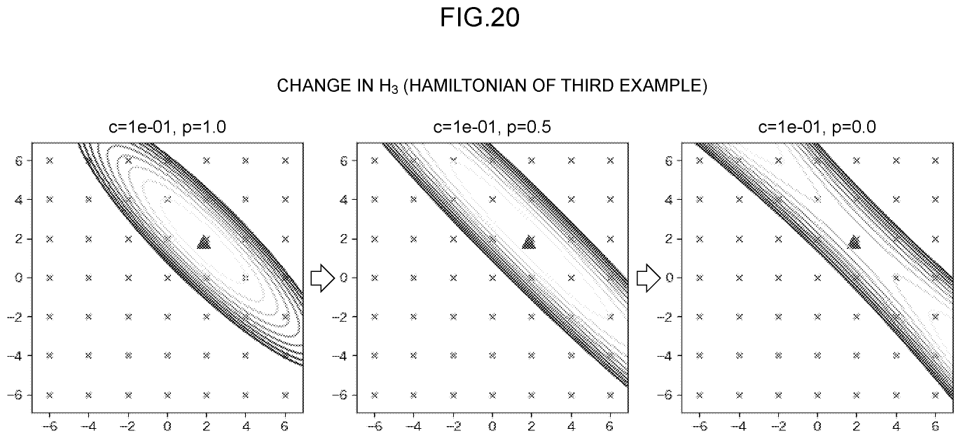

FIG. 20 is a diagram illustrating a change in contour lines of the Hamiltonian (H₃) of the third example in a case in which the minimization problem is a problem of minimizing the augmented Lagrangian function defined by Formula (11) and c=1×10⁻¹.

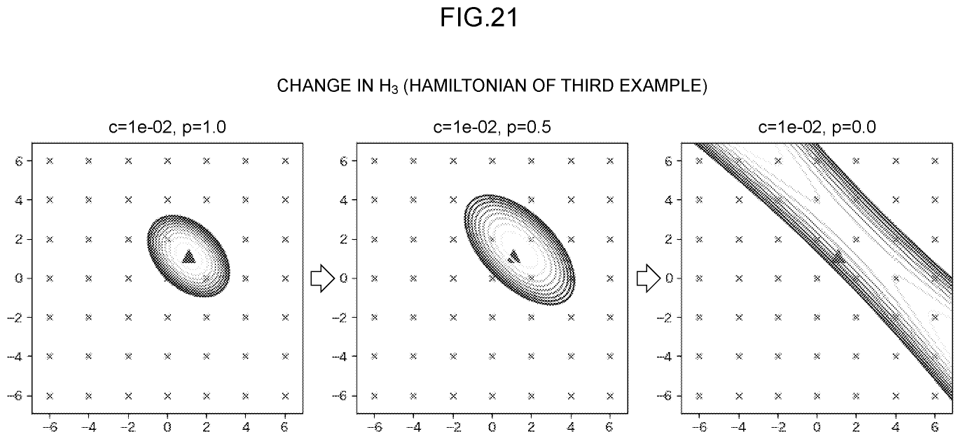

FIG. 21 is a diagram illustrating a change in contour lines of the Hamiltonian (H₃) of the third example in a case in which the minimization problem is a problem of minimizing the augmented Lagrangian function defined by Formula (11) and c=1×10⁻².

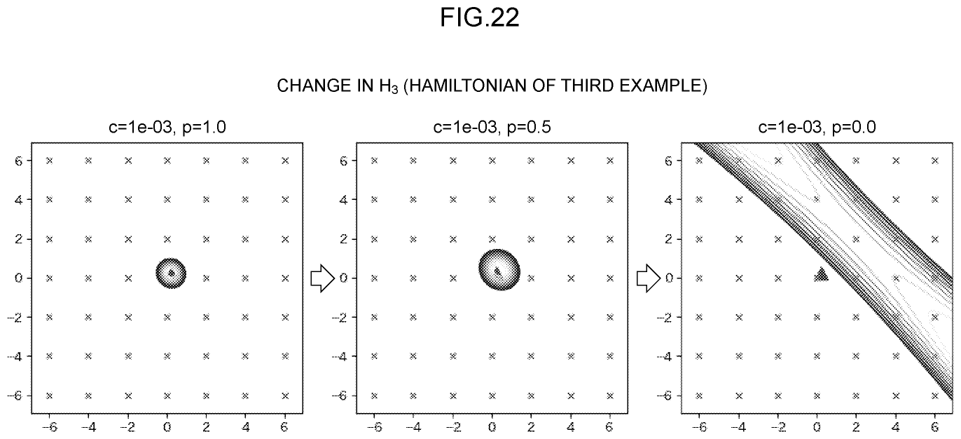

FIG. 22 is a diagram illustrating a change in contour lines of the Hamiltonian (H₃) of the third example in a case in which the minimization problem is a problem of minimizing the augmented Lagrangian function defined by Formula (11) and c=1×10⁻³.

As indicated by contour lines of the Hamiltonian (H₃) of the third example in the case of p=1.0 in FIGS. 20 to 22, the energy difference (ΔE₃) in the third example is substantially 0 regardless of the magnitude of c. In addition, in the conventional Hamiltonian (H₃) of the third example, as c is larger, a shape difference between contour maps of the initial time and the end time is smaller. Therefore, as c is larger, the Hamiltonian (H₃) of the third example can stabilize the motion of the N virtual particles between the initial time and the end time. Therefore, the calculation apparatus 20 can shorten the simulation time until an accurate solution is obtained. As a result, the calculation apparatus 20 according to the third example can stabilize the initial states of the N virtual particles and calculate an accurate solution with a practical calculation amount.

### Fourth Example

In the fourth example, the N position variables at the initial time are defined by Formula (78).

$$x [ 0 ] ∼ 𝒩 ( {x}_{4 , stable} , {σ}_{x}^{2} ) \qquad ( 78 )$$

Furthermore, in the fourth example, the N momentum variables at the initial time are defined by Formula (79).

$$y [ 0 ] ∼ 𝒩 ( 0 , {σ}_{y}^{2} ) \qquad ( 79 )$$

That is, in the fourth example, in the initial state of the N virtual particles, the average value of the energy becomes a value close to a stable point (x_{4,stable}) in the fourth example.

Furthermore, the Hamiltonian (H₄) in the fourth example is defined by Formula (80).

$${H}_{4 , stable} ( x , y ; p ; steps , c , Δ t ) = c \cdot ( \frac{1}{2} {x}^{T} \cdot J \cdot x + {h}^{T} \cdot x ) + \frac{p}{2} \cdot {‖ S ( x ; {x}_{4 , stable} ) ‖}^{2} + \frac{1}{2} \cdot {‖ y ‖}^{2} \qquad ( 80 )$$

S(x) represents a vector including N elements. The i-th element (Sᵢ(xᵢ)) included in S(x) is defined by Formula (81).

$${S}_{i} ( {x}_{i} ) = \{ \begin{matrix}\frac{( {x}_{i} - {x}_{4 , stable , i} )}{\vert - 1 - {x}_{4 , stable , i} \vert} & if {x}_{i} \leq {x}_{4 , stable , i} \\ \frac{( {x}_{i} - {x}_{4 , stable , i} )}{\vert + 1 - {x}_{4 , stable , i} \vert} & if {x}_{4 , stable , i} < {x}_{i}\end{matrix} \qquad ( 81 )$$

xᵢ is the i-th position variable among the N position variables. That is, Sᵢ(xᵢ) is (xᵢ−x_{4,stable,i})/|−1−x_{4,stable,i}| in a case in which xᵢ is greater than or equal to a value (x_{4,stable,i}) representing the position of the i-th virtual particle at the stable point (x_{4,stable}) of the fourth example. Further, Sᵢ(xᵢ) is (xᵢ−x_{4,stable,i})/|+1−x_{4,stable,i}| in a case in which xᵢ is smaller than the value (x_{4,stable,i}) representing the position of the i-th virtual particle at the stable point (x_{4,stable}) of the fourth example.

In addition, the stable point (x_{4,stable}) in the fourth example is capable of being calculated as defined by Formula (82), and is −J⁻¹·h.

$${x}_{4 , stable} = - {J}^{- 1} \cdot h \qquad ( 82 )$$

Since the stable point (x_{4,stable}) in the fourth example is 0, the stable point matches the average value of the N position variables at the initial time.

In addition, an energy difference (ΔE₄) in the fourth example is greater than or equal to 0 and sufficiently smaller than 1, as defined by Formula (83).

$$0 \leq Δ {E}_{4} ≪ 1 \qquad ( 83 )$$

By executing the simulation using the Hamiltonian (H₄) in the fourth example and the initial states of the N virtual particles in the fourth example, the initial states of the N virtual particles are stabilized, and the calculation apparatus 20 can calculate an accurate solution with a practical calculation amount.

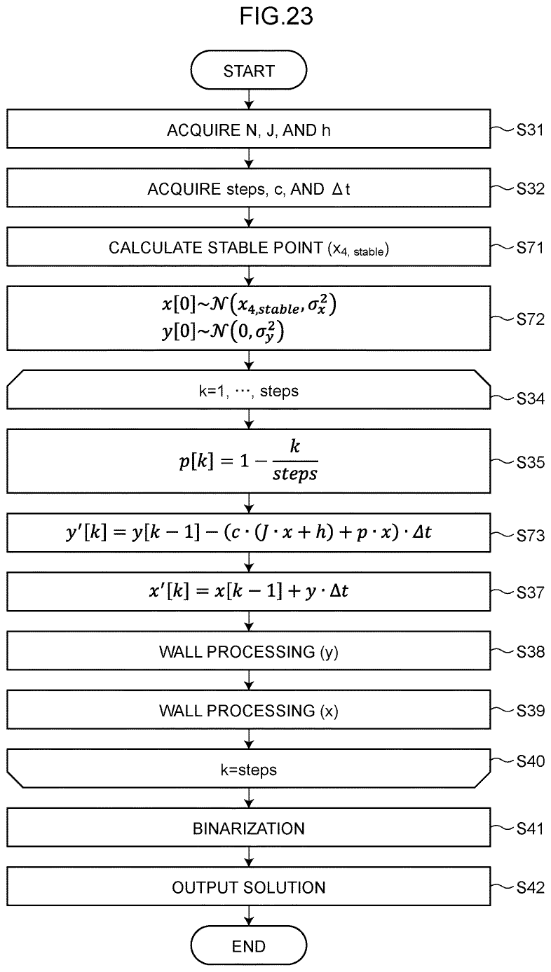

FIG. 23 is a flowchart illustrating a procedure of processing of the calculation apparatus 20 in the fourth example. The calculation apparatus 20 executes simulation according to the simulated bifurcation algorithm in the flow illustrated in FIG. 23. Note that, regarding the processing of the calculation apparatus 20 according to the fourth example, differences from the calculation apparatus 20 of the first example illustrated in FIG. 11 will be described, and description of the matching points will be omitted.

Subsequent to S31, in S71, the calculation apparatus 20 calculates the stable point (x_{4,stable}). Specifically, the calculation apparatus 20 calculates (−J⁻¹·h). After completing S71, the calculation apparatus 20 proceeds to the processing in S32.

Subsequent to S32, in S72, the calculation apparatus 20 initializes the N position variables at the initial time by normal random numbers whose average is x_{4,stable} and whose variance accords with a normal distribution of σₓ², as defined by Formula (84).

$$x [ 0 ] ∼ 𝒩 ( {x}_{4 , stable} , {σ}_{x}^{2} ) \qquad ( 84 )$$

In addition, the calculation apparatus 20 initializes the N momentum variables at the initial time by normal random numbers whose average is 0 and whose variance accords with a normal distribution of σ_{y}², as defined by Formula (85).

$$y [ 0 ] ∼ 𝒩 ( 0 , {σ}_{y}^{2} ) \qquad ( 85 )$$

After completing S72, the calculation apparatus 20 proceeds to the processing in S34.

Following the processing in S35, the calculation apparatus 20 executes momentum update processing in S73. In the fourth example, the calculation apparatus 20 executes the calculation of Formula (86) in the momentum update processing in S73.

$${y}^{′} [ k ] = y [ k - 1 ] - \frac{\partial {H}_{4}}{\partial x} {\vert}_{x = x [ k - 1 ] , y = y [ k - 1 ] , p = p [ k ]} \cdot Δ t \qquad ( 86 )$$

Specifically, Formula (86) is defined by Formula (87).

$${y}^{′} [ k ] = y [ k - 1 ] - ( c \cdot ( J \cdot x + h ) + p \cdot x ) \cdot Δ t \qquad ( 87 )$$

Following the processing in S73, the calculation apparatus 20 executes position update processing in S37. Note that the calculation apparatus 20 may execute the momentum update processing after executing the position update processing. In this case, the calculation apparatus 20 executes the calculation of Formula (88) in the position update processing, and executes the calculation of Formula (89) in the momentum update processing.

$${x}^{′} [ k ] = x [ k - 1 ] + \frac{\partial {H}_{4}}{\partial y} {\vert}_{x = x [ k - 1 ] , y = y [ k - 1 ] , p = p [ k ]} \cdot Δ t \qquad ( 88 )$$

$${y}^{′} [ k ] = y [ k - 1 ] - \frac{\partial {H}_{4}}{\partial x} {\vert}_{x = x ′ [ k - 1 ] , y = y [ k - 1 ] , p = p [ k ]} \cdot Δ t \qquad ( 89 )$$

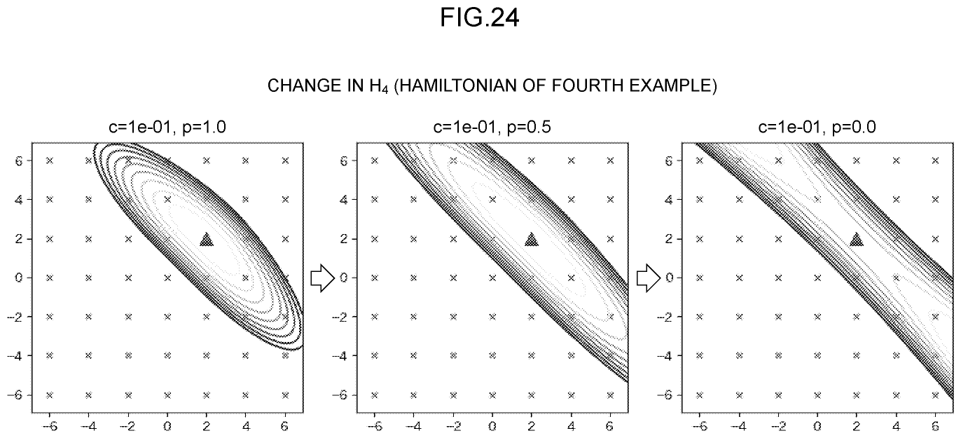

FIG. 24 is a diagram illustrating a change in contour lines of the Hamiltonian (H₄) of the fourth example in a case in which the minimization problem is a problem of minimizing the augmented Lagrangian function defined by Formula (11) and c=1×10⁻¹.

FIG. 24 is a diagram illustrating a change in contour lines of the Hamiltonian (H₄) of the fourth example in a case in which the minimization problem is a problem of minimizing the augmented Lagrangian function defined by Formula (11) and c=1×10⁻².

FIG. 24 is a diagram illustrating a change in contour lines of the Hamiltonian (H₄) of the fourth example in a case in which the minimization problem is a problem of minimizing the augmented Lagrangian function defined by Formula (11) and c=1×10⁻³.

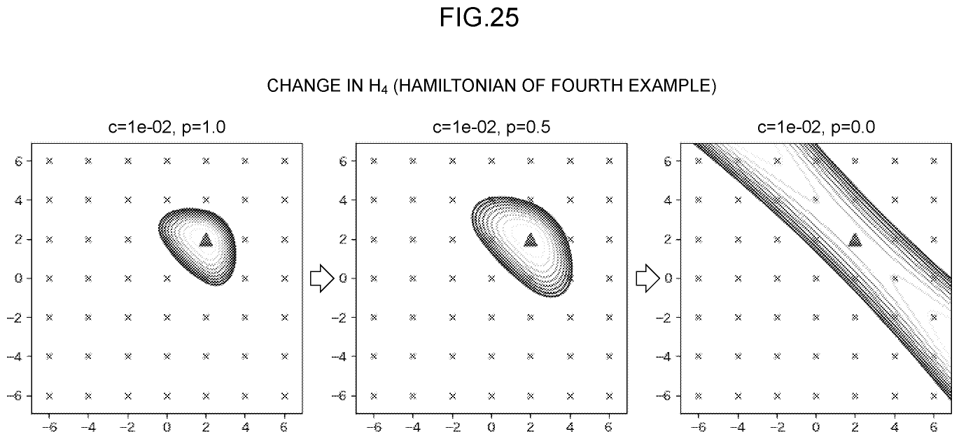

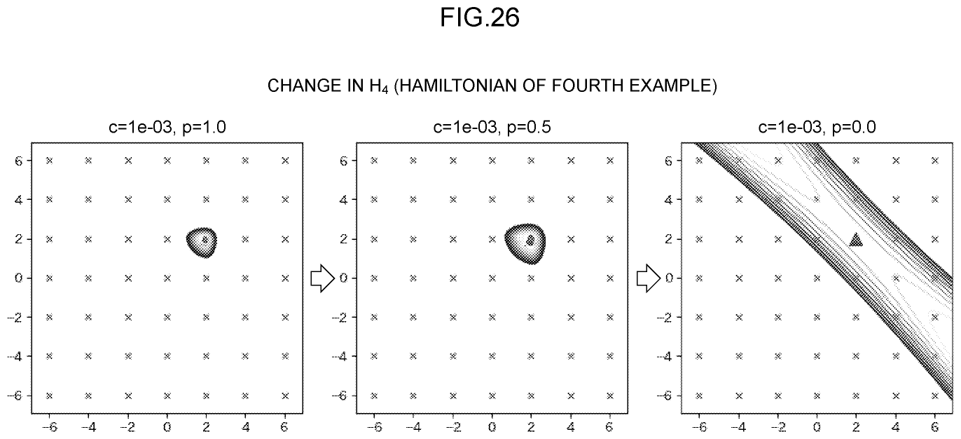

As indicated by contour lines of the Hamiltonian (H₄) of the fourth example in the case of p=1.0 in FIGS. 24 to 26, the energy difference (ΔE₄) in the fourth example is substantially 0 regardless of the magnitude of c. In addition, in the Hamiltonian (H₄) of the fourth example, as c is larger, a shape difference between contour maps of the initial time and the end time is smaller. Therefore, as c is larger, the Hamiltonian (H₄) of the fourth example can stabilize the motion of the N virtual particles between the initial time and the end time. Therefore, the calculation apparatus 20 can shorten the simulation time until an accurate solution is obtained. As a result, the calculation apparatus 20 according to the fourth example can stabilize the initial states of the N virtual particles and calculate an accurate solution with a practical calculation amount.

### Comparison of Calculation Amount

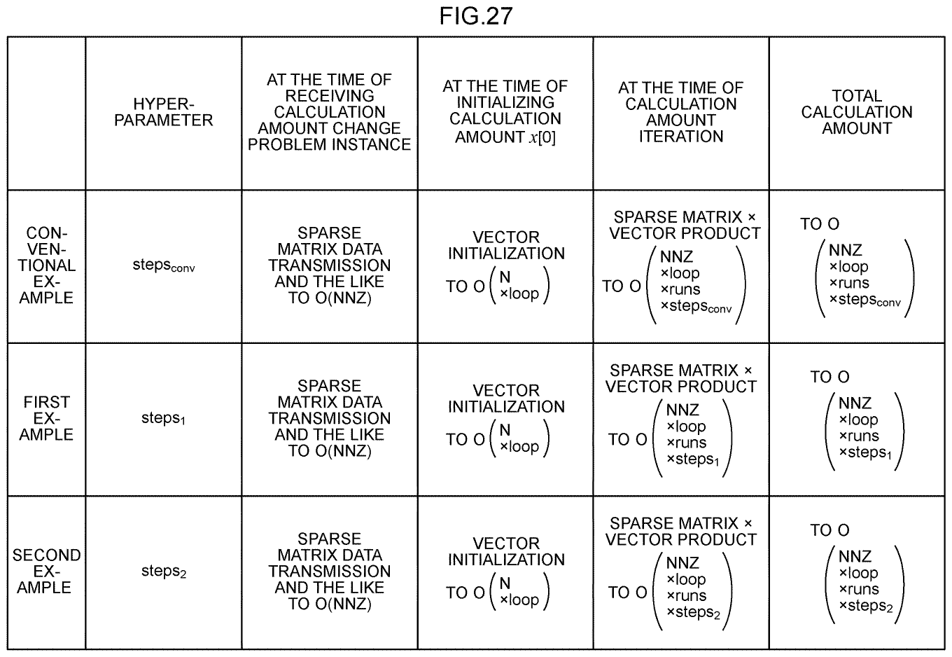

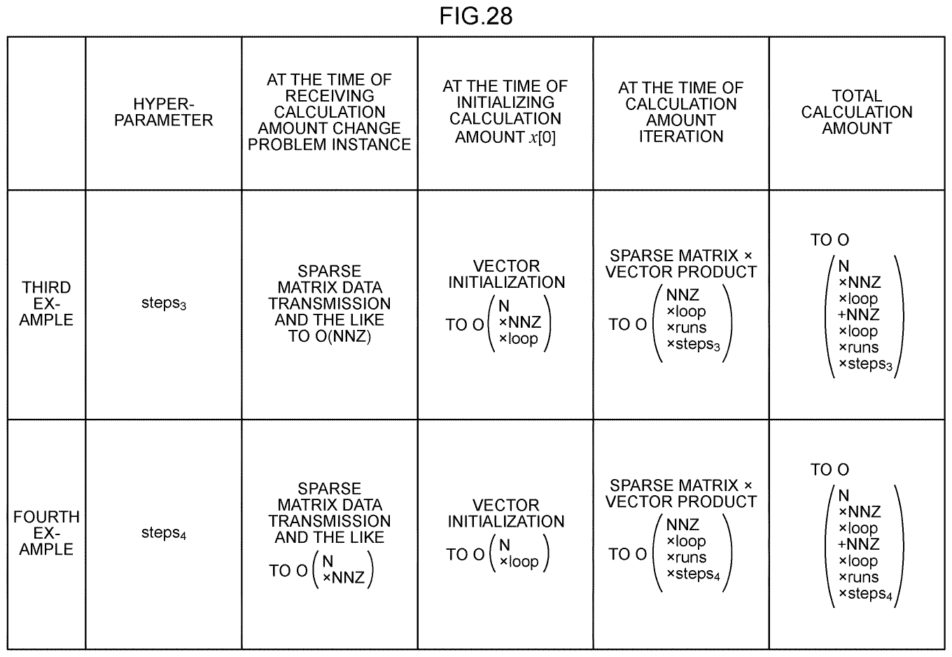

FIG. 27 is a diagram illustrating a calculation amount in a case in which the conventional Hamiltonian (H₀) and the initial state are used, a calculation amount in a case in which the Hamiltonian (H₁) of the first example and the initial state are used, and a calculation amount in a case where the Hamiltonian (H₂) of the second example and the initial state are used. FIG. 28 is a diagram illustrating a calculation amount in a case in which the Hamiltonian (H₃) of the third example and the initial state are used, and a calculation amount in a case in which the Hamiltonian (H₄) of the fourth example and the initial state are used.

In FIGS. 27 and 28, the hyperparameter indicates steps which are the number of repetitions. However, steps at which an accurate solution can be obtained are different in each example, and thus different subscripts are attached for each example. The number of repetitions of the conventional Hamiltonian (H₀) is represented by step_{sconv}. The number of repetitions of the Hamiltonian (H₁) of the first example is represented as step₁. The number of repetitions of the Hamiltonian (H₂) of the second example is represented as step₂. The number of repetitions of the Hamiltonian (H₃) of the third example is represented as step₃. The number of repetitions of the Hamiltonian (H₄) of the fourth example is represented as step₄.

O ( ) (O in the drawing is in an oblique form) indicates that a calculation amount in a specific algorithm is an order of a numerical value in parentheses. NNZ represents the number of non-zero elements in the J matrix. N represents the number of spin variables. loop represents the number of loops of solving processing for the minimization problem in the case of calculating rans minimization solutions in parallel.

In a case in which a linear term of an objective function is large, steps in each example are defined by Formula (90).

$${steps}_{conv} ≫ {steps}_{1} , {steps}_{2} ≫ {steps}_{3} , {steps}_{4} \qquad ( 90 )$$

When the linear term of the objective function is large, the first example and the second example are superior to the conventional example. When the linear term of the objective function is large, the fourth example is superior to the third example.

In a case in which the linear term of the objective function is large and loop×runs×steps is sufficiently larger than N, the fourth example is superior to the first example and the second example. In a case in which the linear term of the objective function is large and loop×runs×steps is less than or equal to N, the first example and the second example are superior to the fourth example.

When the linear term of the objective function is small, steps in each example are defined by Formula (91).

$${steps}_{conv} ≳ {steps}_{1} , {steps}_{2} ≳ {steps}_{3} , {steps}_{4} \qquad ( 91 )$$

When the linear term of the objective function is small, the first example and the second example are similar to the conventional example. When the linear term of the objective function is small, the conventional example, the first example, and the second example are superior to the third example and the fourth example.

As described above, even in a case in which the calculation apparatus 20 according to the present embodiment solves the Ising problem in which the coefficient vector (h) representing the external magnetic field coefficient is larger than the coefficient matrix (J) representing the interaction, the momentum of the plurality of virtual particles does not become too large at the initial stage of the simulation, and the positions of the plurality of virtual particles do not become unstable. Therefore, the calculation apparatus 20 according to the present embodiment can accurately solve the minimization problem that minimizes the non-convex quadratic objective function with a small amount of calculation.

### Hardware Configuration

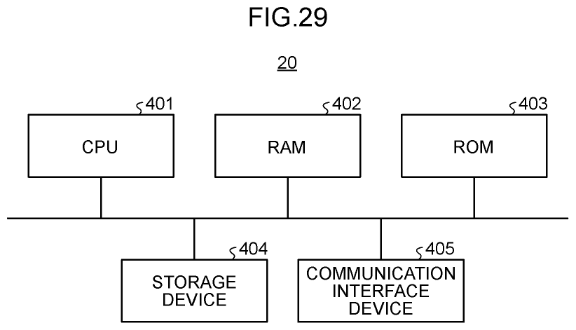

FIG. 29 is a diagram illustrating an example of a hardware configuration of a computer. The calculation apparatus 20 is implemented by, for example, a computer having a hardware configuration as illustrated in FIG. 29. The calculation apparatus 20 includes a central processing unit (CPU) 401, a random access memory (RAM) 402, a read only memory (ROM) 403, a storage device 404, and a communication interface device 405. These units are connected to each other by a bus.

The CPU 401 is one or more processors that execute arithmetic processing, control processing, and the like in accordance with computer programs. The CPU 401 uses a predetermined area of the RAM 402 as a work area, and executes various types of processing according to computer programs stored in the ROM 403, the storage device 404, and the like.

The RAM 402 is a memory such as a synchronous dynamic random access memory (SDRAM). The RAM 402 functions as a work area of the CPU 401. The ROM 403 is a memory that stores programs and various types of information in a non-rewritable manner.

The storage device 404 is a device that writes and reads data to and from a semiconductor storage medium such as a flash memory, a magnetically or optically recordable storage medium, or the like. The storage device 404 writes and reads data to and from the storage medium under the control of the CPU 401. The communication interface device 405 communicates with an external device via a network in accordance with control from the CPU 401.

The program executed by the computer causes the computer to function as the calculation apparatus 20. This program is loaded into the RAM 402 and is executed by the CPU 401 (processor).

In addition, the program executed by the computer can be provided as a computer program product by being recorded in a computer-readable recording medium such as a CD-ROM, a flexible disk, a CD-R, or a digital versatile disk (DVD) as a file in a format that can be installed or executed in the computer.

Furthermore, the program may be configured to be stored on a computer connected to a network such as the Internet and to be provided by being downloaded via the network. Furthermore, the program may be configured to be provided or distributed via a network such as the Internet. In addition, the program executed by the calculation apparatus 20 may be configured to be provided by being incorporated in the ROM 403 or the like in advance.

A computer program for causing a computer to function as the calculation apparatus 20 includes an input module, a setting module, a calculation module, and an output module. This program is executed by the CPU 401, whereby each module is loaded into the RAM 402, and causes the CPU 401 to function as a processing unit (hardware processor) including the input unit 42, the setting unit 44, the calculation unit 50, and the output unit 52. When the CPU 401 is configured as multiple processors, the above-noted units may be distributed and implemented by the multiple processors. Note that some of or all these configurations may be configured by hardware. In addition, the program for causing the computer to function as the calculation apparatus 20 causes the RAM 402 and the storage device 404 to function as the position variable memory 46 and the momentum variable memory 48.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A calculation apparatus serving to solve a minimization problem of minimizing a non-convex quadratic objective function including N spin variables (N is an integer greater than or equal to 2), the calculation apparatus comprising a hardware processor connected to a memory, wherein
the hardware processor is configured to
simulate, for each unit time from an initial time to an end time, a position and a momentum of each of N virtual particles while reducing an adiabatic change parameter of a Hamiltonian over time, and
calculate a value of each of the N spin variables based on the corresponding position of each of the N virtual particles at the end time and output the calculated value of each of the N spin variables as a solution to the minimization problem,
the N spin variables correspond one-to-one to the N virtual particles,
the Hamiltonian is represented by N position variables, N momentum variables, the adiabatic change parameter, a N-by-N coefficient matrix representing a coefficient group of quadratic terms included in the non-convex quadratic objective function, and a N-row coefficient vector representing a coefficient group of linear terms included in the non-convex quadratic objective function,
the N position variables correspond one-to-one to the N virtual particles,
each of the N position variables represents a position of a corresponding virtual particle among the N virtual particles,
the N momentum variables correspond one-to-one to the N virtual particles,
each of the N momentum variables represents a momentum of a corresponding virtual particle among the N virtual particles,
the hardware processor is configured to
acquire the coefficient matrix and the coefficient vector,
set respective values of the N position variables and respective values of the N momentum variables at the initial time, and
alternately repeat momentum update processing and position update processing for each unit time, the momentum update processing being processing of updating an i-th momentum variable (i is an integer from 1 to N both inclusive) among the N momentum variables by adding, to the i-th momentum variable, a value obtained by multiplying the unit time by a value obtained by performing partial differentiation on the Hamiltonian with an i-th position variable among the N position variables, the position update processing being processing of updating the i-th position variable by adding, to the i-th position variable, a value obtained by multiplying the unit time by a value obtained by performing partial differentiation on the Hamiltonian with the i-th momentum variable,
the Hamiltonian is capable of calculating a stable point at the initial time, the stable point indicating a value of each of the N position variables in which each of the N momentum variables is 0, and
each of the N position variables at the initial time is a value obtained by adding a normal random number to the stable point at the initial time.

2. The calculation apparatus according to claim 1, wherein the Hamiltonian at the end time is the same as Formula (1) at the end time
$${H}_{0} ( x , y ; p ; steps , c , Δ t ) = c \cdot ( \frac{1}{2} {x}^{T} \cdot J \cdot x + {h}^{T} \cdot x ) + \frac{p}{2} \cdot {‖ x ‖}^{2} + \frac{1}{2} \cdot {‖ y ‖}^{2} , \qquad ( 1 )$$
x is a vector representing the N position variables,
y is a vector representing the N momentum variables,
x^{T} is a transposed vector of x,
∥x∥ represents a norm of x,
∥y∥ represents a norm of y,
J is the coefficient matrix,
h is the coefficient vector,
h^{T} is a transposed vector of h,
c is a real number greater than 0,
Δt represents the unit time,
steps is an integer greater than or equal to 2 and is a value obtained by dividing time from the initial time to the end time by the unit time, and
p is the adiabatic change parameter, is 1 at the initial time, is 0 at the end time, and decreases every unit time from the initial time to the end time.

3. The calculation apparatus according to claim 1, wherein
the N position variables at the initial time are defined by Formula (2)
$$x [ 0 ] \sim 𝒩 ( 0 , {σ}_{x}^{2} ) , \qquad ( 2 )$$
x(0) represents x at the initial time,
N(0, σₓ²) represents random numbers whose average is 0 and whose variance accords with a predetermined normal distribution of σₓ²,
the N momentum variables at the initial time are defined by Formula (3)
$$y [ 0 ] \sim 𝒩 ( 0 , {σ}_{y}^{2} ) , \qquad ( 3 )$$
y(0) represents y at the initial time,
N(0, σ_{y}²) represents random numbers whose average is 0 and whose variance accords with a predetermined normal distribution of σ_{y}², and
the Hamiltonian is defined by Formula (4)
$${H}_{1} ( x , y ; p ; staps , c , Δ t ) = ( 1 - p ) \cdot c \cdot ( \frac{1}{2} {x}^{T} \cdot J \cdot x \cdot {h}^{T} \cdot x ) + \frac{p}{2} \cdot {‖ x ‖}^{2} + \frac{1}{2} \cdot {‖ y ‖}^{2} , \qquad ( 4 )$$
and
the stable point is 0.

4. The calculation apparatus according to claim 1, wherein
the N position variables at the initial time are defined by Formula (5)
$$x [ 0 ] \sim 𝒩 ( 0 , {σ}_{x}^{2} ) , \qquad ( 5 )$$
x(0) represents x at the initial time,
N(0, σₓ²) represents random numbers whose average is 0 and whose variance accords with a predetermined normal distribution of σₓ²,
the N momentum variables at the initial time are defined by Formula (6)
$$y [ 0 ] \sim 𝒩 ( 0 , {σ}_{y}^{2} ) , \qquad ( 6 )$$
y(0) represents y at the initial time,
N(0, σ_{y}²) represents random numbers whose average is 0 and whose variance accords with a predetermined normal distribution of σ_{y}²,
the Hamiltonian is defined by Formula (7)
$${H}_{2} ( x , y ; p ; steps , c , Δ t ) = c \cdot ( \frac{1}{2} {x}^{T} \cdot J \cdot x + ( 1 - p ) \cdot {h}^{T} \cdot x ) + \frac{p}{2} \cdot {‖ x ‖}^{2} + \frac{1}{2} \cdot {‖ y ‖}^{2} , \qquad ( 7 )$$
and
the stable point is 0.

5. The calculation apparatus according to claim 1, wherein
the N position variables at the initial time are defined by Formula (8)
$$x [ 0 ] \sim 𝒩 ( {x}_{3 , stable} ( c ) , {σ}_{x}^{2} ) , \qquad ( 8 )$$
x(0) represents x at the initial time,
N(x_{3,stable}(c), σₓ²) represents random numbers whose average is x_{3,stable}(c) and whose variance accords with a predetermined normal distribution of σₓ²,
the N momentum variables at the initial time are defined by Formula (9)
$$y [ 0 ] \sim 𝒩 ( 0 , {σ}_{y}^{2} ) , \qquad ( 9 )$$
y(0) represents y at the initial time,
N(0, σ_{y}²) represents random numbers whose average is 0 and whose variance accords with a predetermined normal distribution of σ_{y}²,
the Hamiltonian is defined by Formula (10)
$${H}_{3} ( x , y ; p ; steps , c , Δ t ) = c \cdot ( \frac{1}{2} {x}^{T} \cdot J \cdot x \cdot {h}^{T} \cdot x ) + \frac{p}{2} \cdot {‖ x ‖}^{2} + \frac{1}{2} \cdot {‖ y ‖}^{2} , \qquad ( 10 )$$
the stable point is x_{3,stable}(c) defined by Formula (11)
$${x}_{3 , stable} ( c ) = \frac{- c \cdot h}{c \cdot J + I} , \qquad ( 11 )$$
and
I is a N-by-N unit matrix.

6. The calculation apparatus according to claim 1, wherein
the N position variables at the initial time are defined by Formula (12)
$$x [ 0 ] \sim 𝒩 ( {x}_{3 , stable} ( c ) , {σ}_{x}^{2} ) , \qquad ( 12 )$$
x(0) represents x at the initial time,
N(−J⁻¹·h, σₓ²) represents random numbers whose average is x_{4,stable}(c) and whose variance accords with a predetermined normal distribution of σₓ²,
the N momentum variables at the initial time are defined by Formula (13)
$$y [ 0 ] \sim 𝒩 ( 0 , {σ}_{y}^{2} ) , \qquad ( 13 )$$
y(0) represents y at the initial time,
N(0, σ_{y}²) represents random numbers whose average is 0 and whose variance accords with a predetermined normal distribution of σ_{y}²,
the Hamiltonian is defined by Formula (14)
$${H}_{5} ( x , y ; p ; steps , c , Δ t ) = c \cdot ( \frac{1}{2} {x}^{T} \cdot J \cdot x \cdot {h}^{T} \cdot x ) + \frac{p}{2} \cdot {‖ x ‖}^{2} + \frac{1}{2} \cdot {‖ y ‖}^{2} , \qquad ( 14 )$$
S(x) is a vector including N elements,
an i-th element (Sᵢ(xᵢ)) included in S(x) is defined by Formula (15)
$${S}_{i} ( {x}_{i} ) = \{ \begin{matrix}\frac{( {x}_{i} - {x}_{4 , stable , i} )}{\vert - 1 - {x}_{4 , stable , i} \vert} & if {x}_{i} \leq {x}_{4 , stable , i} \\ \frac{( {x}_{i} - {x}_{4 , stable , i} )}{\vert + 1 - {x}_{4 , stable , i} \vert} & if {x}_{4 , stable , i} < {x}_{i}\end{matrix} , \qquad ( 15 )$$
xᵢ represents an i-th position variable among the N position variables, and
the stable point is x_{4,stable} defined by Formula (16)
$${x}_{4 , stable} = - {J}^{- 1} \cdot h \qquad ( 16 )$$

7. A calculation method implemented by a computer to solve a minimization problem of minimizing a non-convex quadratic objective function including N spin variables (N is an integer greater than or equal to 2), the calculation method comprising:
simulating, for each unit time from an initial time to an end time, a position and a momentum of each of N virtual particles while reducing an adiabatic change parameter of a Hamiltonian over time; and
calculating a value of each of the N spin variables based on the corresponding position of each of the N virtual particles at the end time and outputting the calculated value of each of the N spin variables as a solution to the minimization problem, wherein
the N spin variables correspond one-to-one to the N virtual particles,
the Hamiltonian is represented by N position variables, N momentum variables, the adiabatic change parameter, a N-by-N coefficient matrix representing a coefficient group of quadratic terms included in the non-convex quadratic objective function, and a N-row coefficient vector representing a coefficient group of linear terms included in the non-convex quadratic objective function,
the N position variables correspond one-to-one to the N virtual particles,
each of the N position variables represents a position of a corresponding virtual particle among the N virtual particles,
the N momentum variables correspond one-to-one to the N virtual particles,
each of the N momentum variables represents a momentum of a corresponding virtual particle among the N virtual particles,
the simulating includes:
acquiring the coefficient matrix and the coefficient vector;
setting respective values of the N position variables and respective values of the N momentum variables at the initial time; and
alternately repeating momentum update processing and position update processing for each unit time, the momentum update processing being processing of updating an i-th momentum variable (i is an integer from 1 to N both inclusive) among the N momentum variables by adding, to the i-th momentum variable, a value obtained by multiplying the unit time by a value obtained by performing partial differentiation on the Hamiltonian with an i-th position variable among the N position variables, the position update processing being processing of updating the i-th position variable by adding, to the i-th position variable, a value obtained by multiplying the unit time by a value obtained by performing partial differentiation on the Hamiltonian with the i-th momentum variable,
the Hamiltonian is capable of calculating a stable point at the initial time, the stable point indicating a value of each of the N position variables in which each of the N momentum variables is 0, and
each of the N position variables at the initial time is a value obtained by adding a normal random number to the stable point at the initial time.

8. A computer program product comprising a non-transitory computer readable recording medium on which a computer program executable by a computer is recorded, the computer program instructing the computer to perform:
simulating, for each unit time from an initial time to an end time, a position and a momentum of each of N virtual particles while reducing an adiabatic change parameter of a Hamiltonian over time; and
calculating a value of each of the N spin variables based on the corresponding position of each of the N virtual particles at the end time and outputting the calculated value of each of the N spin variables as a solution to the minimization problem, wherein
the N spin variables correspond one-to-one to the N virtual particles,
the Hamiltonian is represented by N position variables, N momentum variables, the adiabatic change parameter, a N-by-N coefficient matrix representing a coefficient group of quadratic terms included in the non-convex quadratic objective function, and a N-row coefficient vector representing a coefficient group of linear terms included in the non-convex quadratic objective function,
the N position variables correspond one-to-one to the N virtual particles,
each of the N position variables represents a position of a corresponding virtual particle among the N virtual particles,
the N momentum variables correspond one-to-one to the N virtual particles,
each of the N momentum variables represents a momentum of a corresponding virtual particle among the N virtual particles,
the simulating includes:
acquiring the coefficient matrix and the coefficient vector;
setting respective values of the N position variables and respective values of the N momentum variables at the initial time; and
alternately repeating momentum update processing and position update processing for each unit time, the momentum update processing being processing of updating an i-th momentum variable (i is an integer from 1 to N both inclusive) among the N momentum variables by adding, to the i-th momentum variable, a value obtained by multiplying the unit time by a value obtained by performing partial differentiation on the Hamiltonian with an i-th position variable among the N position variables, the position update processing being processing of updating the i-th position variable by adding, to the i-th position variable, a value obtained by multiplying the unit time by a value obtained by performing partial differentiation on the Hamiltonian with the i-th momentum variable,
the Hamiltonian is capable of calculating a stable point at the initial time, the stable point indicating a value of each of the N position variables in which each of the N momentum variables is 0, and
each of the N position variables at the initial time is a value obtained by adding a normal random number to the stable point at the initial time.
